(19) United States
(12) Patent Application Publication
(10) Pub. No.: US 2015/0177362 A1
(43) Pub. Date: Jun. 25, 2015

(54) PROXIMITY TAGS FOR VEHICLES

(71) Applicant: ACCO Brands Corporation, Lake Zurich, IL (US)

(72) Inventors: Gerald A. Gutierrez, Richmond (CA); Corey Davyduke, Port Coquitlam (CA); Barry Marshall, Santa Clara, CA (US); George L. Foot, San Mateo, CA (US); Juan Ernesto Rodriguez, Woodside, CA (US); Lee Harrison, Wilstead Bedfordshire (GB)

(73) Assignee: ACCO Brands Corporation, Lake Zurich, IL (US)

(21) Appl. No.: 14/405,729

(22) PCT Filed: Mar. 13, 2014
(86) PCT No.: PCT/US14/25370

§ 371 Date: Dec. 4, 2014

Related U.S. Application Data
(60) Provisional application No. 61/780,576, filed on Mar. 13, 2013.

(51) Int. Cl. G01S 5/02

(52) U.S. Cl. CPC G01S 5/0294

(57) ABSTRACT

An object tracking system includes a wireless device having a first antenna, a first transceiver coupled to the first antenna, and a sensor coupled to the first transceiver and configured to monitor a parameter of the vehicle. The parameter is related to an operational state of the vehicle. The object tracking system also includes a mobile communication device having a second antenna, a second transceiver coupled to the second antenna and configured to communicate with the wireless device, and a processor coupled to the second transceiver. The processor is operable to generate a first list of objects when the vehicle is in a first operational state, generate a second list of wireless when the vehicle is in a second operational state, and compare the second list of objects to the first list of objects.

### CROSS REFERENCE TO RELATED APPLICATIONS

The present application is claims priority to U.S. Provisional Patent Application No 61/780,576, filed Mar. 13, 2013, the entire contents of which are incorporated by reference herein.

### BACKGROUND

A person typically carries several important items such as identity papers, mobile electronics including those that contain personal information, and objects of convenience on which modern life depends. However, daily life also presents many distractions that lead to accidental loss. Furthermore, construction workers, salesmen, and other professionals that may travel with a large number of different items for their jobs, may have trouble keeping track of all of their items and making sure everything they arrived with at a location, leaves with them. The day-to-day time challenges further compound the problems as one usually has little time to discover or locate such lost items, Loss of such items is inconvenient at the least and leads to identity theft at the worst. Additionally, the proliferation of mobile electronics has increased the rates of theft and accidental loss. The increasing performance and versatility of such products have also increased the immediate and consequential costs of such losses in the form of replacement and potential breach of privacy.

Accordingly, there is a need to provide a fast, easy, and effective system for ensuring that as user has possession of all of the important items they arrived with at a location before they leave.

Additionally, people have long had trouble remembering their parking locations and determining directions for returning to their parking location from their present location when in an unfamiliar location. Accordingly, there is a need to provide to fast, easy and effective system for remembering a user's parking location and providing directions to the parking location from their current location.

### SUMMARY

The devices and systems described in this document relate to at system of loss prevention, discovery, and tracking of personal belongings in the context of traveling from locations through the use of wireless hardware associated with a vehicle, wireless hardware associated with important objects, and mobile communication devices such as smartphones, tablet computers, and portable computers. Specifically, embodiments of the present invention are directed at systems and methods to monitor the parking location of a vehicle using wireless devices coupled to the vehicle's electrical system (“vehicle tags”) and monitor the inventory of personal possessions using small radio transceivers (e.g., “tags”) attached to objects of interest (i.e. “Monitored objects”) based on the operational state of the vehicle. The vehicle tag, and object tags may wirelessly connect to and communicate with a mobile communication device such as a smartphone, a tablet computer, or a wearable device with computing capabilities running a vehicle tag and object inventory application. The mobile communication device may perform a number of functions based on the operational state of the vehicle as reported by the vehicle tag.

The application may determine the operational state of the vehicle and may store an inventory of the tags that are within communication range of the mobile communication device when the operational state of the vehicle indicates the vehicle has parked. The application may then determine a second inventory of the tags that are within communication range of the mobile communication device when the operational state of the vehicle indicates that the vehicle is running and may alert a user if the tag inventories do not match.

Additionally, in some embodiments, the application may communicate with the vehicle tag to determine and store the parking location of the vehicle when the operational state of the vehicle indicates the vehicle is parked. The application may then provide directions from the current location of the mobile communication device to the previously stored parking location in order to allow a user to quickly, efficiently, and easily return to their vehicle.

In one embodiment, the invention provides an object tracking system including a wireless device coupled to a vehicle. The wireless device includes a first antenna, a first transceiver electrically coupled to the first antenna, and a sensor coupled to the first transceiver and configured to monitor a parameter of the vehicle. The parameter is related to an operational state of the vehicle. The system. also includes a mobile communication device having a second antenna, a second transceiver electrically coupled to the second antenna to communicate with the wireless device, and a processor coupled to the second transceiver. The processor is operable to generate a first list of objects that are located within a communication range of the second transceiver when the vehicle is in a first operational state, generate a second list of objects that are located within the communication range of the second transceiver when the vehicle is in a second operational state, and compare the second list of objects to the first list of objects.

In another embodiment, the invention provides a method of tracking objects using an object tracking system. The object tracking system includes a wireless device and a mobile communication device. The wireless device includes a first transceiver and a sensor. The mobile communication device includes a second transceiver and a processor. The method includes coupling the wireless device to a vehicle to monitor a parameter of the vehicle. The parameter is related to an operational state of the vehicle. The method also includes determining the operational state of the vehicle based on the parameter of the vehicle, generating, by the processor, a first list of objects that are located within a communication range of the second transceiver when the vehicle is in a first operational state, generating, by the processor, a second list of objects that are located within the communication range of the second transceiver when the vehicle is in a second operational state, and comparing the second list of objects to the first list of objects.

In another embodiment, the invention provides a mobile communication device configured to communicate with as wireless device connected to a vehicle. The wireless device includes a sensor configured to monitor a parameter of the vehicle that is related to an operational state of the vehicle. The mobile communication device includes an antenna, a transceiver electrically coupled to the antenna, and a processor. The transceiver is configured to communicate with the wireless device. The processor is coupled to the transceiver and is operable to generate a first list of objects that are located within a communication range of the transceiver when the vehicle is in a first operational state, generate a second list of objects that are located within the communication range of the second transceiver when the vehicle is in a second operational state, and compare the second list of objects to the first list of objects.

In yet another embodiment, the invention provides a wireless device configured to couple to a vehicle and communicate with a mobile communication device. The wireless device includes an antenna, a transceiver electrically coupled to the antenna, a sensor coupled to the first transceiver, and a processor. The transceiver is configured to communicate with the mobile communication device, The sensor is configured to monitor a parameter of the vehicle. The parameter is related to an operational state of the vehicle. The processor is coupled to the sensor and the transceiver. The processor is operable to determine an operational state of the vehicle based on the parameter from the sensor, send a first wireless signal to the mobile communication device when the vehicle is in a first operational state such that the mobile communication device generates a first list of objects within a communication range of the mobile communication device, and send a second wireless signal to the mobile communication device when the vehicle is in a second operational state such that the mobile communication device generates a second list of objects within the communication range of the mobile communication device.

In still another embodiment, the invention provides a non-transitory computer program product including a computer usable medium having a computer-readable code stored thereon. The computer-readable program code includes instructions that, when executed by a mobile communication device having a processor and a transceiver, cause the mobile communication device t& receive a wireless communication from a wireless device that is coupled to a vehicle. The wireless communication includes information regarding an operational state of the vehicle, The instructions also cause the mobile communication device to generate a first list of objects that are located within a communication range of the transceiver when the vehicle is in a first operational state, generate a second list of objects that are located within the communication range of the transceiver when the vehicle is in a second operational state, and compare the second list of objects to the first list of objects.

Other aspects of the invention will become apparent by consideration of the detailed description and accompanying drawings.

### BRIEF DESCRIPTION OF THE DRAWINGS

FIG. 1 is a block diagram of an object tracking system according to one embodiment of the invention.

FIG. 2 illustrates the object tracking system, including a vehicle tag, a mobile communication device, and a tag.

FIG. 3 is a perspective view of the vehicle tag of the object tracking system.

FIG. 4 is a transition state diagram for the object tracking system.

FIG. 5 is a diagram of designated zones for the vehicle tag.

FIG. 6 is a flowchart of a method of determining and reporting an operational state of a vehicle by the vehicle tag.

FIG. 7 is a flowchart of a method of determining a parking location performed by the mobile communication device.

FIG. 8 is a flowchart of a method of tag inventory monitoring by the mobile communication device.

FIGS. 9A-9C are block diagrams of an exemplary method of tag inventory monitoring by the mobile communication device.

FIGS. 10-12 are exemplary screenshots of an application running on the mobile communication device,

FIG. 13 is a block diagram of an exemplary computer system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Embodiments of the present invention relate to identifying and monitoring, the operational state of a vehicle and identifying, monitoring, and storing inventories of objects of interest to a user based on the operational state of the vehicle as well as determining a parking location of the vehicle based on the operational state of the vehicle and providing directions to a user for returning to the location of the vehicle.

For example, according to embodiments of the present invention, a mobile communication device, such as a smartphone, may be in continual wireless communication with a wireless device that is electrically coupled to an automobile. The wireless device, called a “vehicle tag,” may be coupled to the electrical system of the automobile through, for example, a cigarette lighter adapter (CLA). The vehicle tag monitors the operational state of the automobile through the electrical coupling of the vehicle tag to the automobile's electrical system, Additionally, the vehicle tag, may monitor the operational state of the automobile through other means including, but are not limited to, monitoring the vibration of the automobile and other characteristics of the automobile's electrical system. The vehicle tag periodically transmits the data collected such as the voltage reading of the electrical system, other characteristics of the electrical system, the presence or absence of expected vibration due to the motion of the vehicle, and the strength of the signal received from the mobile communication device.

The vehicle tag and/or the mobile communication device may determine the operational state of the automobile based on the readings and other information monitored by the vehicle tag. Accordingly, the system may determine whether the engine of the automobile is stopped or running. If the engine goes from running to stopped, the vehicle tag may determine that the automobile is parked and an operational state of the vehicle may indicate that the automobile is parked. Alternatively, if the engine is determined to move from a parked state to a running state, the operational state of the automobile may be determined to be running. Depending on the determined operational state of the vehicle, the mobile communication device may store a parking location of the vehicle, store an inventory of objects of interest that are within communication range of the mobile communication device, and/or compare the stored inventory of objects to the current objects that are within communication range with the mobile communication device to determine if a user should be alerted due to at missing tag.

Accordingly, some embodiments of the present invention monitor the presence of wireless devices that are attached to objects of interest to a user based on the operational state of a vehicle. For example, embodiments of the present invention determine and store an inventory of wireless devices that are within communication range of the mobile communication device when a vehicle is parked (i.e., generate a tag inventory). The wireless devices may be attached to objects of interest (e.g., tools, equipment, valuable items, etc.) and as such, the system may provide an inventory of these important objects, articles, or other items that a user is interested in monitoring

Embodiments may further generate another wireless device inventory (tag inventory) when the vehicle is determined to be running again, and may alert a. user if any tags (and corresponding articles of interest) that were in the original inventory are not present once the vehicle is running again. The alert may include information about which item is missing, the last monitored location of the item, and any other information relevant to the user. Accordingly, the user may be notified or alerted before leaving the proximity of the location and may be able to avoid, losing an object or having to backtrack all the locations they visited in a day to determine where they left their important object.

According to embodiments of the present invention, application software (a vehicle tag and object inventory application) may operate on the mobile communication device that may monitor the data received from the vehicle tag and determine the operational state of the vehicle (e.g.., engine running, engine stopped (i.e., parked), accessory power mode, etc.). Depending on the determined mode the application may perform a number of operations. For example, if the vehicle is determined to be parked, the application may record the location of the mobile communication device, the time, and the date of the parking event. The application may provide additional services such as, for example, a parking timer, a reminder to alert the user to return to the automobile before the parking, time limit, and store an inventory of wireless devices within communication range of the mobile communication device for later comparison to determine missing items (as described above).

Further, the application may include functions that assist the user to locate and return to the automobile. For example, the application may provide a map with a suggested route that leads from the user's current location to the parking location recorded previously. Alternatively, assisting the user to return to the vehicle may be provided in the form of a compass and direction indication showing, the direction where the vehicle may be found. Any other means of informing a user of a parking location may be implemented. Additionally, the application may modify the time of the parking reminder to account for the time it would take to return to the automobile. The application may also record and keep a history of all of the locations at which the vehicle has been parked in the past. The location records may be automatically correlated to a database of special locations such as known client/customer addresses. These records may be exported to accounting or time management software for further processing.

Additionally, the system may incorporate tags and fobs that may be attached to objects and may communicate with the mobile phone. The mobile phone may alert a user if a tag moves out of a predetermined proximity range from the mobile device, or if a monitored tag that is supposed to be stationary is detected to be moving. The mobile phone continually transmits wireless communications to connected and authenticated tags. A tag periodically monitors the signal strength of messages received from the mobile phone by determining a received signal strength indicator (“RSSI”) reading and sends the RSSI readings to the mobile phone. An object tracking and monitoring application running, on the mobile phone may determine the behavior of the tag and the system as a whole using the RSSI readings. If a tag's signal strength readings go below a certain alert threshold, a user may be alerted. Additionally, functionality relating to setting an adaptive threshold (signal strength threshold can change based on environment), adaptive transmission rate (rate of transmission changes when battery is low or if the connection status changes), and adaptive transmission power (transmission power is lowered when battery low) can be used to improve system performance and battery life. The tag and fob functionality is disclosed in related U.S. application Ser. No. 13/612,576, titled “Proximity Tag for Object Tracking,” filed Sep. 12, 2012, by Gutierrez et al., which is incorporated herein, in its entirety, for all purposes.

Additionally, the vehicle tag may incorporate all of the functions and features of the tags and fobs described in related U.S. application Ser. No. 13/612,576, titled “Proximity Tag for Object Tracking,” filed Sep. 12, 2012, by Gutierrez et al. For example, the vehicle tag may determine a signal strength reading and may include this information in a wireless communication sent to a mobile communication device, as described in the related application referenced above. The mobile communication device may then determine the operational state of the vehicle from the wireless communication by determining a signal strength reading from the wireless communication, determining if the signal strength reading is below an alert threshold, and if the signal strength reading is below the alert threshold, setting the operational state of the vehicle to parked. Accordingly, the vehicle tag, may incorporate any and all features described in the above-referenced application, as well as the additional features described herein.

Accordingly, the mobile communication device may also determine that a vehicle is parked by the communication tether being broken between the vehicle tag and the mobile communication device. Accordingly, once as mobile communication device is paired with a vehicle tag, if the mobile communication device loses contact with the wireless device (i.e., vehicle tag) before determining that the operational state of the vehicle is parked, the mobile communication device may determine that the vehicle is parked by waiting a predetermined period of time for a wireless communication from a wireless device, and if no wireless communication is received, setting the operational state of the vehicle to parked. For the sake of brevity, all of the functionality of the above-referenced application tags may not be described herein but it should be clear that the adaptive thresholds, numerous alarms and alerts, and other features described in the above-referenced application which is incorporated by reference, may be used to determine when a vehicle is parked, and therefore, when a location should be stored as a parking location, and when an inventory of the surrounding wireless devices should be taken.

Accordingly, embodiments of the present invention may provide a system with a vehicle tag that may be fully integrated with the power supply of the vehicle (e.g., through the CLA electrical system input), may monitor the operational state of the vehicle through analyzing the voltage levels of the vehicle's electrical system, signal strength of received signals, and movement characteristics of the vehicle tag, may manage multiple vehicles (through the mobile communication device), and may monitor other objects including providing a tag inventory when parking and when about to leave a location using the vehicle.

Embodiments of the present invention provide a number of technical advantages. The security system provides a simple, efficient, interactive, customizable, and effective solution to monitoring objects of interest and notifying a user if an object. of interest that was present when the user arrived at the location, is no longer present when the user is leaving the location. The system allows a consumer to rest assured that they are not inadvertently leaving their objects of interest behind when they are leaving locations and that the user will be notified if their objects of interest are left behind. Additionally, embodiments of the present invention provide a simple and effective solution to determining where a vehicle is parked and determining directions for returning to their vehicle.

Prior to discussing particular embodiments of the technology, a further description of some terms can provide a better understanding of embodiments of the technology.

A “wireless device” can include any electronic device that includes a means for communicating with a mobile communication device or another electronic device. For example, a wireless device may include a vehicle tag, a tag, a fob, or a zone tag that communicates with a mobile communication device. The wireless device may be an independent device or may be a sub-component or portion of another device. Additionally, the wireless device may comprise any means for communicating with the mobile communication device including a transmitter, receiver, transceiver, separate antenna, or any other components that are suitable for sending and receiving wireless communication signals. The wireless device may also comprise components that allow it to alert a user to its location if it is paged or in some embodiments, if the wireless device enters an alarm condition.

There may be multiple types of wireless devices. For example, wireless devices may include a tag, a vehicle tag, a fob, and a zone tag. A “tag” may be attached to an object of interest and may be tracked using the mobile communication device so that a user may be alerted when the monitored object leaves a pre-selected sensitivity setting, cannot be found by the user, or any other suitable time that a user may wish to know where the monitored object is located. The tag may be portable or small enough that a user can attach the tag to a personal object without interfering with the operation or utility of the personal object.

A “vehicle tag” may comprise a specialized tag (i.e., wireless device) that is configured to be attached to a vehicle. For example, the vehicle tag, may include all of the components of a tag as well as cigarette lighter adapter (CIA) components that allow the vehicle tag to electrically and removably couple to the electrical system of a vehicle. The vehicle tag may have all of the components integrated into a single housing or may have the CLA components and the tag components separated but electrically coupled. Alternatively, the vehicle tag may be hard-wired, securably coupled, or otherwise integrated into the electrical system of the vehicle. The vehicle tag may measure the voltage and other electrical characteristics of the electrical system of the vehicle and may communicate the voltage readings and voltage characteristics to the mobile communication device. Additionally, the vehicle tag may comprise movement sensors (e.g., accelerometers) that may allow a vehicle tag to measure and report acceleration, vibration, or other movement characteristics to the mobile communication device. In some embodiments, the vehicle tag may comprise a computer-readable medium including software that is capable of determining the operational state of the vehicle and may report the operational state to the mobile communication device instead of or in addition to the voltage reading.

A “mobile communication device” can include any electronic device with a means for communicating with other electronic devices or wireless device. The mobile communication device may include a mobile phone, tablet, digital music player, netbook, laptop, or any other electrical device that comprises a means for wireless communication. The mobile communication device may be wirelessly coupled to one or more wireless devices through any suitable wireless communication components and communication protocols (e.g., Bluetooth™ Low Energy communications), The mobile communication device and a wireless device may share information through wireless communications that include commands, data to be stored on a memory of either device, or any other information that may control the behavior of the mobile communication device or the wireless device. While the description below focuses on mobile communication devices, aspects of the invention may be implemented with any portable device and should not be limited to mobile communication devices alone. Additionally, the mobile communication device may communicate with multiple wireless devices at the same or substantially similar time and the following description should not be limited to a single pairing of a mobile communication device and wireless device. Additionally, settings on the vehicle tag and object inventory application may be implemented such that different settings affect different wireless devices.

A “wireless signal request” can include any wireless communication signal, data message, data package, or data stream sent by an electronic device requesting a response from another electronic device. For example, the mobile communication device may send a wireless signal request to the wireless device requesting a response message. The wireless signal request may comprise commands, state or operational information, responses to a previous communication received from the wireless device, or any other data that would be useful to share between electronic devices. The information may be shared through any suitable communication scheme including cellular network communication, short-range communications (e.g., Bluetooth™ or other short-range communication), interact or WI-FI communications, or any other suitable communication scheme as would be recognized by one of ordinary skill in the art.

A “wireless signal response” can include any wireless communication signal, data message, data package, or data stream sent by an electronic device in response to a wireless signal request received from another electronic. device. For example, the wireless device may send a wireless signal response back to the mobile communication device in response to a wireless signal request. Similar to the wireless signal request, the wireless signal response may comprise commands, state or operational information, responses to a previous communication received from the second wireless device, or any other data that would be useful to share between electronic devices. The information may be shared through any suitable communication scheme including, cellular network communication, short-range communications (e.g., Bluetooth™ or other near-field communication), internet or WI-FI communications, or any other suitable communication scheme as would be recognized by one of ordinary skill in the art.

Additionally, the wireless signal response may be transmitted periodically based on a single wireless signal request that, for example, initiated a series of wireless signal response messages. For example, a vehicle tag may receive a single message setting a response schedule for the vehicle tag and the vehicle tag may continue to issue wireless signal responses to the single wireless signal request. Furthermore, in some embodiments, the wireless signal response may be sent without a specific request being provided by a mobile communication device, For example, when the vehicle tag is operating in a broadcast mode, the vehicle tag may send periodic wireless signal responses that may be received by any mobile communication device within communication range.

An “operational state of a vehicle” may include any operating mode, status, or functionality of a vehicle. For example, a car may have a number of operational states determined by the engine of the car including “running,” “accessory power,” and “parked” or “stopped.”

A “running” or “engine running” operational state may include any operational state where the engine of the vehicle is twining. For instance, if the vehicle is a car, the car may be moving, may be stopped and parked but the engine may be running (e.g., idle), may be stopped waiting for a traffic light to change, or otherwise may have an engine that is running, no matter whether the car is moving or stopped.

An “accessory power” operational state may include any operational state where the engine is not started but the electrical system of the car is turned on. For example, in typical cars, an accessory power status may be entered when a user of the car places the keys M the ignition and turns the keys to turn to a first level where the power Systems are turned on, without starting the vehicle's engine. The accessory power status may power as vehicle tag coupled to the electrical system of the vehicle but may not change the operational state of the vehicle tag to include a running state from a parked (“engine stopped”) state and vice versa.

A “parked” or “engine stopped” operational state may include any operational state where the engine is off. Typically, during this operational state, the vehicle tag may not receive power from the vehicle's electrical system. While there may be some overlap in the parked or engine stopped operational state and the accessory power operational state, the accessory power status may provide a different voltage level to the vehicle tag than typically provided during a running operational state and thus, even if the vehicle tag remains powered through an accessory power status being entered by the vehicle, the vehicle tag may determine that the operational state of the vehicle no longer includes running and may be able to determine which operational state is present depending on whether the tag is operational or not.

A “voltage reading” may include. any measurement of an electrical system. For example, the voltage reading may include a measurement of the voltage level of an electrical system of a vehicle at an electrical input or output. For instance, a vehicle tag may determine a voltage reading of a vehicle by measuring the voltage at the cigarette lighter adapter (CLA) plug of the vehicle tag that is an input to the vehicle's electrical system. The voltage reading may provide a vehicle tag or mobile communication device information regarding the operational state of a vehicle (i.e., a voltage reading may change depending on the operational state of the vehicle). Accordingly, the vehicle tag may report the voltage reading to a mobile communication device and the voltage reading may be used to determine an operational state of a vehicle.

The operational state of the vehicle may be determined using the voltage reading by comparing the voltage reading to a voltage threshold. A voltage threshold may include a predetermined voltage level that indicates whether a vehicle's engine is running. For example, if the voltage reading is below the voltage threshold, the operational state of the vehicle may be set to indicate the vehicle is parked or stopped. For instance, when automobiles alternators are operating, the electrical system of the automobile may have an output voltage of 14.4 volts instead of the typical battery voltage of 12 volts. Accordingly, by comparing the measured voltage to a voltage threshold of 14 volts, the mobile communication device or the vehicle tag may be able to determine whether the automobile's engine is running (e.g., voltage reading above 14 volts) or not (e.g., voltage reading of 12 volts). Accordingly, the operational state of the automobile may be determined by the vehicle tag or the mobile communication device using the voltage readings. The voltage threshold may be adjustable by a user or the mobile communication device depending on the type of vehicle being operated. A similar determination may be performed for any vehicle that comprises an engine and electrical system.

Additionally, “movement characteristics” may include acceleration, vibration, or other effects or forces on movement sensors included in the vehicle tag. In some embodiments, the movement characteristics may be reported to a mobile communication device and may provide additional information in order for an accurate determination of an operational state of a vehicle. For example, when the vehicle is an automobile, the movement characteristics measured by the vehicle tag including the acceleration measured by an accelerometer may inform a vehicle tag that the vehicle is not parked even though the engine may no longer be “running” or the voltage may be below the voltage threshold. Accordingly, if a movement sensor (e.g., accelerometer) in a wireless device determines that the wireless device is being moved, the wireless device may include a movement indicator in the next wireless signal response sent to the mobile communication device. The movement characteristics may be used by a vehicle, tag to provide warnings regarding the operation of the vehicle including warnings that the vehicle is being operated too quickly, is over the speed limit, etc. For example, if an accelerometer determines that an acceleration reading is too high and the vehicle is being operated in a manner that is not efficient, the vehicle tag may warn the user, inform the user, log the action, etc.

In embodiments Of the present invention, a “movement indicator” may include any suitable data that informs an electronic device that a wireless device is sensing movement. For example, the movement indicator could be implemented as a flag, a sensor reading from a movement sensor (e.g., accelerometer), a message comprising particular information including location data, or any other suitable message that informs a mobile communication device that the wireless device has sensed that it is being moved. The movement indicator may be sensor readings that require additional processing before a determination can be made of how the device is being moved or the processing may occur at the wireless device and the mobile communication device may receive pre-processed data indicating the type of movement or that movement has occurred.

An “operational state reading” may include any determination from a wireless device attached to a vehicle of the operational state of the vehicle. For example, the vehicle tag may make a determination of the operational state of the vehicle based on a voltage, movement characteristics, or through any other suitable method disclosed herein. After determining the operational state of the vehicle, the vehicle tag may determine an operational state reading that may inform a mobile communication device as to the current operational state of the vehicle. For example, the operational state reading may include a flag, binary digit reading, code, or any other information that may be interpreted by a mobile communication device as providing the operational state of the vehicle. For instance, when a vehicle is in a running state, the operational state reading may include a single digit, “1”. Accordingly, if the vehicle is in a parked, engine stopped, or engine off operational state, the operational state reading may include a “0”. Accordingly, the mobile communication device may immediately understand the operational state of the vehicle and may make decisions and take actions accordingly. For example, when a mobile communication device receives an operational state reading that changes to a 0 from a previous operational state reading of 1, the mobile communication device immediately knows that the vehicle tag is indicating that the vehicle has entered an operational state of off, engine off, engine stopped, etc., and that the vehicle is parked. Accordingly, the location of the mobile communication device may be stored in a parking location database for future reference. Accordingly, the most accurate parking location may be determined because the mobile communication device does not move from the vehicle before the parking location is determined.

A “user input” can include any input by a user on an electrical device. For example, the data input may be the touching of a particular area of a display screen that is configured to send a particular command to the processor of an electrical device (e.g., touch screen input) or may include the compression or engagement of a physical button or input on an electrical device (e.g., power button, volume up or down button, etc). In embodiments of the present invention, data inputs may include, commands to enter operational modes, engage or disengage features, control the volume, change Screen display settings, navigate through an application or operating system, or may be used to provide consumer information including a password, as well as implementing any other features that may be useful in the present invention.

A “set of wireless devices” may include any number of wireless device that are determined to be within communication distance with a mobile communication device. The set of wireless devices may also be known as a wireless device inventory or tag inventory and may comprise is list of wireless devices (i.e., a list of objects) that responded to a wireless request message from the mobile communication device. The set of wireless devices or tag inventory may be stored in a tag inventory database or memory element and may be used in embodiments of the present invention to compare a previous number of tags within communication range of the mobile communication device to a current set of wireless devices or tags that are within communication range of the mobile communication device. If the previous and the current tag inventories or sets of wireless devices do not match, a user may be alerted.

A “movement distance” may include any measurement of distance determined through any method. For example, a mobile communication device may determine a movement distance through monitoring the movement characteristics provided by a movement sensor (e.g., accelerometer), may determine the movement distance by tracking the mobile communication devices location using position components (e.g., GPS receiver system), triangulation of communication messages with wireless communication towers, or through any other suitable manner. Additionally, the mobile communication device may determine the movement distance in relation to an event including for example, since the operational state of the vehicle indicated that the vehicle is running. Accordingly, the mobile communication device may use the movement distance to ensure that the mobile communication device has moved a sufficient distance that any sensors surrounding the vehicle, but not contained in the vehicle, are not unintentionally included in an inventory of wireless devices within communication range of the mobile communication device.

A “movement distance threshold” may include any minimum distance that a mobile communication device may move before an additional wireless device inventory may be taken. In some embodiments of the present invention, a mobile communication device may compare the determined movement distance to a movement distance threshold, and if the movement distance is larger than the movement distance threshold, the mobile communication device may determine an additional inventory of the wireless devices within radio communication range of the mobile communication device. Accordingly, any wireless devices that were within communication range of the mobile communication device when the engine of the vehicle was started, may now be outside of communication range with the mobile communication device and thus, may not be included in any wireless device inventory taken after the movement distance threshold has been reached. Accordingly, the mobile communication device may then compare the inventory of the wireless devices to previous inventories taken at start up or parking of the vehicle and may alert a user if any wireless devices were left behind, but were originally within communication range of the mobile communication device (i.e., were located outside the car but were close enough to communicate with the mobile communication device at start up or when the engine was first running).

“Alerting a user” can include any actions taken by an electronic device to get a user's attention. For example, these actions may include generating audible alarms, physical vibrations, flashing lights, sending emails or short messages (SMS) or status updates (through social media websites like Twitter™) initiated from either a wireless device or the mobile communication device, The actions may be initiated by command, messages, or signals generated by any of the devices. For example, an application on a mobile communication device may determine that an inventory of wireless devices when a vehicle is determined to be leaving a parking location, does not match the inventory of wireless devices from when the vehicle parked. Accordingly, the mobile communication device may alert the user and/or may send an alarm command to the wireless device to alert the user. The wireless device and/or mobile communication device may enter an alarm condition that may include activating flashing lights, making a noise, vibrating, or any other action to get the user's attention. Additionally, in some embodiments where the wireless device is meant to not be detected by others, the wireless device may not enter the alarm condition and instead only he mobile communication device may alert the user. Lithe mobile communication device is in the user's pocket, hand, or within eye sight, the user may sense the movement, hear the noise, or see the flashing and may be alerted that the mobile communication device has entered an alarm condition based on a wireless device being left behind or a wireless device inventory not matching a previously stored wireless device inventory. Additionally, the system may develop different alerting modes for different types of alarms.

### 1. Exemplary Systems

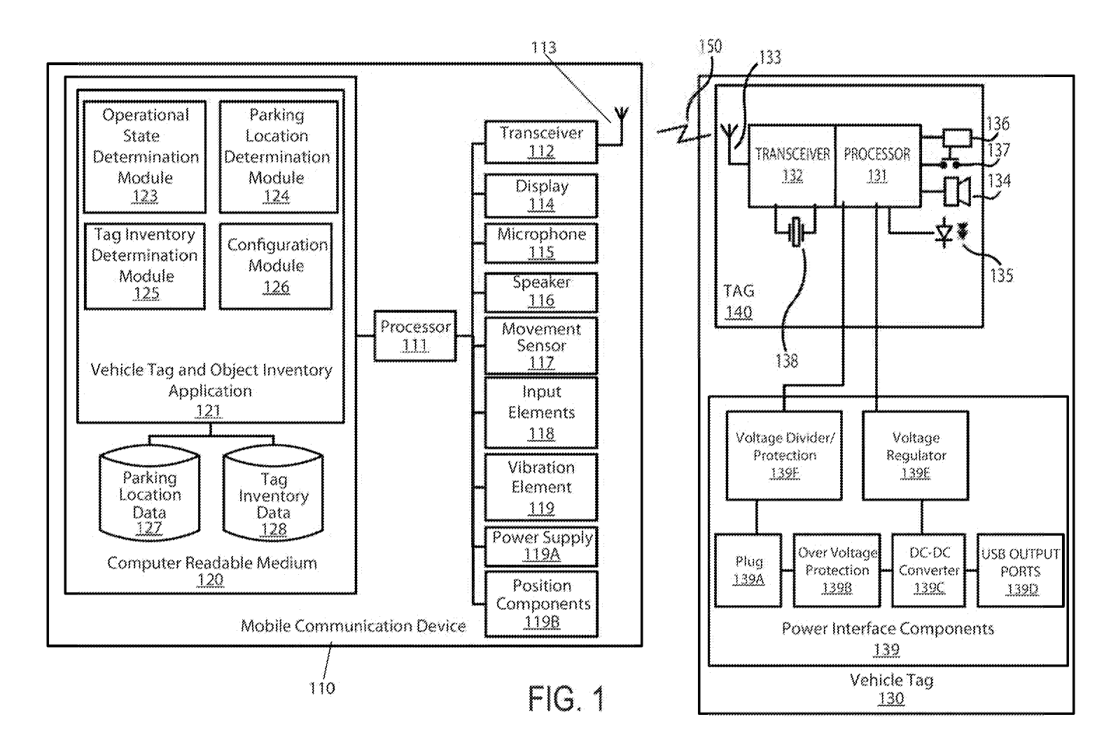

FIG. 1 shows a block diagram in accordance to embodiments of the invention. Embodiments of the invention relate to a vehicle tag 130 and object tracking system 100 comprising three parts: a mobile communication device 110, a wireless device (or wireless apparatus) in the form of a tag 140, and a wireless device in the form of a vehicle tag 130 attached to a vehicle. The vehicle may include any object that may be used to travel to or from a location. For example, the vehicle may include an automobile, motorcycle, boat, powered bicycle, helicopter, or any other object that a user may use to travel. A monitored object may be any object that a user may desire to track, monitor, or be alerted to if the object is missing from their possession before they leave in the vehicle. For example, the monitored object may be a camera, a briefcase, a bag, car, car keys, computer, tablet computer, tools, construction equipment, etc., with a tag attached to the monitored object. The mobile communication device 110 may be a mobile phone, smartphone, or other portable device capable of communication with a wireless device.

The mobile communication device 110 may comprise a processor device 111 (e.g., a microcontroller or microprocessor), a transceiver device 112, and an antenna 113 coupled to the transceiver device 112. The transceiver device 112 may be a chip, card, or any other device comprising both receiver circuitry and transmitter circuitry capable of sending and receiving communication messages using the antenna 113, and may implement any suitable communication protocol (e.g., Bluetooth™ Low Energy). The transceiver device 112 may be coupled to the processor 111. The processor 111 may also be coupled to a computer readable medium 120 comprising code for a vehicle tag and object inventory application 121 according to embodiments of the present invention. The computer readable medium 120 may further comprise storage for parking location data 127 and tag inventory data 128. Additionally, the mobile communication device 110 may comprise an accelerometer 117 (e.g., a movement sensor), power supply 119A (e.g., battery), input elements 118 (e.g. buttons, switches, microphone, touchscreen, or any other input component), output components (e.g., a speaker 116, a light emitting diode (LED), vibration element 119, etc.), and position components 119B (e.g., a global positioning system (GPS) receiver or any other components for determining the location of the mobile communication device 110).

The vehicle tag 130 and object inventory application 121 may comprise a vehicle operational state determination module 123, a parking location determination module 124, a tag inventory determination module 125, and a configuration module 126.

The vehicle operational state determination module 123 may determine the operational state of the vehicle coupled to the vehicle tag 130. The vehicle operational state determination module 123 may determine the operational state of the vehicle through multiple methods, For example, the vehicle operational state determination module 123 may determine a voltage reading from the wireless communication, may compare the voltage reading to a voltage threshold, and if the voltage reading is below the voltage threshold, may set the operational state of the vehicle to a first operational state (i.e., parked). Alternatively, the vehicle operational state determination module 123 may determine the operational state of the vehicle from the wireless communication by determining the operational state reading from the wireless communication. The vehicle operational state determination module 123 may then determine the operational state of the vehicle from the operational state reading. Additionally, in some embodiments, the vehicle operational state determination module 123 may use a movement indicator from a received wireless communication to determine the operational state of the vehicle. The vehicle operational state determination module 123 may determine that the vehicle is in the parked operational state when the movement indicator indicates that the vehicle is not moving, and may determine that the vehicle is in the moving operational state when the movement indicator indicates that the vehicle is in motion.

The parking location determination module 124 may determine a location of a vehicle when the operational state of the vehicle is parked and may be used to generate directions to return a user to the vehicle from the current location of the mobile communication device 110, The parking location determination module 124 may use any number of components and databases or storage mediums of the mobile communication device 110. Additionally, the parking location determination module 124 may communicate with external systems in determining a parking location and directions to the parking locations. For example, the mobile communication device 110 may communicate with external databases and servers to generate the directions that are presented to the user.

The tag inventory determination module 125 may determine a tag inventory when a vehicle is in a parked (i.e., a first operational state) or running (i.e., a second operational state) state, may determine a set of wireless devices (e.g., a list of objects that are attached to the tags 140) that are within communication range of the mobile communication device 110, may store the tag inventory (i.e., the list of objects) for later reference, may determine if any tags are missing from the tag inventory when the user is leaving the location in the vehicle, and may alert a user if any tags (i.e., the objects) are missing.

The configuration module 126 may determine settings and information about the status of the system and may update configuration settings for the wireless devices and profile settings of the mobile communication device 110 according to the system status. The configuration settings may include a transmission rate of voltage readings for a wireless device coupled to a vehicle (i.e., vehicle tag) and signal strength readings for wireless devices coupled to monitored items (i.e., tag), a transmission power for the wireless devices, etc.

The wireless device in the form of a vehicle tag 130 (the wireless device attached, removably coupled, and/or electrically coupled to a vehicle) may comprise two primary components. First, the vehicle tag 130 includes the components and circuitry of a typical tag 140, Second, the vehicle tag 130 comprises power interface components 139 (e.g., cigarette lighter adapter (CLA) components) that are used to power the vehicle tag 130 and monitor the voltage and/or power levels of the vehicle to determine the operational state of the vehicle, as described herein. The power interface components 139 may convert the power from the vehicle's electrical system input (e.g., cigarette lighter) into a voltage that is appropriate for charging mobile devices.

The vehicle to 130 may comprise a processor device 131 (e, a microcontroller or microprocessor), a transceiver device 132, and an antenna 133 coupled to the transceiver device 132, The transceiver device 132 may be a chip, card, or any other device comprising both receiver circuitry and transmitter circuitry capable of sending and receiving communication messages using the antenna 133, and may implement any suitable communication protocol. A crystal oscillator 138 may provide a clock for the transceiver device 132. The transceiver device 132 may be coupled to the processor 131, The processor 131 may comprise or may be coupled to a computer readable medium (not shown) comprising code for performing methods according to embodiments of the present invention. Additionally, the vehicle tag 130 may comprise a movement sensor (e.g. accelerometer) 136, an input button. 137, and output components 134, 135 (e.g., a speaker 134, a light emitting diode (LED) 135, vibrating element, etc.). When the vehicle tag 130 is coupled to the vehicle, the movement sensor 136 monitors a parameter of the vehicle (i.e., movement of the vehicle). An exemplary embodiment of the vehicle tag 130 is shown in FIG. 1.

The power interface components 139 (e.g., CLA components) may include a plug 139A, an over-voltage protection component 139B, a DC-DC voltage converter 139C, a voltage output port 139D (e.g., USB output port), a voltage regulator 139E, and a voltage divider with protection circuit 139F (i.e., a voltage sensor). Some of the power interface components 139A-139F convert the voltage from the electrical system of the vehicle (e.g., 12 volts) into a lower DC Voltage (e.g., 5 volts and 2.1 amps) which is provided to the user via the USB output port 139D. The tag circuitry 140 including a processor 131 and a transceiver 132 use the converted output voltage from the DC-DC converter 139C that is fed into a voltage regulator 139E to decrease the voltage down to a usable level for the processor chip 131. Accordingly, the vehicle tag 130 may be powered through the power interface components 139A-139F. Additionally, the voltage divider with protection circuit 139F may measure another parameter of the vehicle. The voltage divider 139F measures the voltage at the plug 139A of the power interface and outputs a voltage reading of the electrical system of the vehicle.

The processor 131 (e.g., microcontroller or microprocessor) manages the operation of the vehicle tag 130 including pairing, connecting, and performing mutual authentication with a mobile communication device 110, responding to commands received from the mobile communication device 110, measuring and reporting the strength of a received radio signal from the mobile communication device 110, measuring and reporting a voltage reading, reporting a movement indicator (i.e. the acceleration the vehicle tag 130 experiences during movement), and generating audio, visual, and mechanical indications and alerts. The vehicle tag 130 may authenticate itself to the vehicle tag and object inventory application 121 running on a mobile communication device 110 and may authenticate the vehicle tag 130 and object inventory application 121 as well. The vehicle tag 130 may report product and capability information to the application 121 once authenticated. Additionally, the vehicle tag 130 may report radio telemetry and the button-press status to the application 121. The vehicle tag 130 may additionally actuate the LED 135 and the buzzer 134 by playing user-configurable audio.

Input button 137 may be a user interface that may allow the user to control the functionality of the vehicle tag 130. For example, the input button 137 may activate certain functionality (e.g., pairing, mute, power, etc,) for the vehicle tag 130.

Output components 134,135 may be any mechanisms for alerting a user (e.g., a buzzer, vibrator, LED light, etc.). For example, in FIG. 1 the vehicle tag 130 output components 134, 135 include a speaker 134 and a LED 135. Any suitable output can be implemented and the output components may not be limited to those shown in FIG. 1.

Additionally, the vehicle tag 130 may include non-volatile storage for parameters, at least serial number and pairing information, and possibly also configurable settings such as beeper volume. For example, the transceiver 132 in the vehicle tag 130 may comprise flash memory (not shown) including up to two pages intended for storage of data. The processor 131 can erase and write to this memory. Because erasing and writing flash takes time, the vehicle tag 130 may be unresponsive to inputs for a short period. Therefore in the vehicle tag 130, the on-chip flash memory can likely be used for configuration settings The transceiver 132 may further comprise an analog digital converter (ADC) that may be suitable for measuring the battery voltage.

As explained previously, the capabilities explained above regarding the vehicle tag 130 (outside of the measuring and reporting of a voltage reading of the vehicle may all be provided in a tag 140. As can be seen in FIG. 1, the vehicle tag 130 is in large part a tag 140 with additional power interface components and voltage measuring components to provide additional functionality. More details regarding the tag 140 functionality may be found in U.S. application Ser. No. 13/612,576, titled “Proximity Tag for Object Tracking,” filed Sep. 12, 2012, by Gutierrez el al., which is incorporated herein, in its entirety, for all purposes.

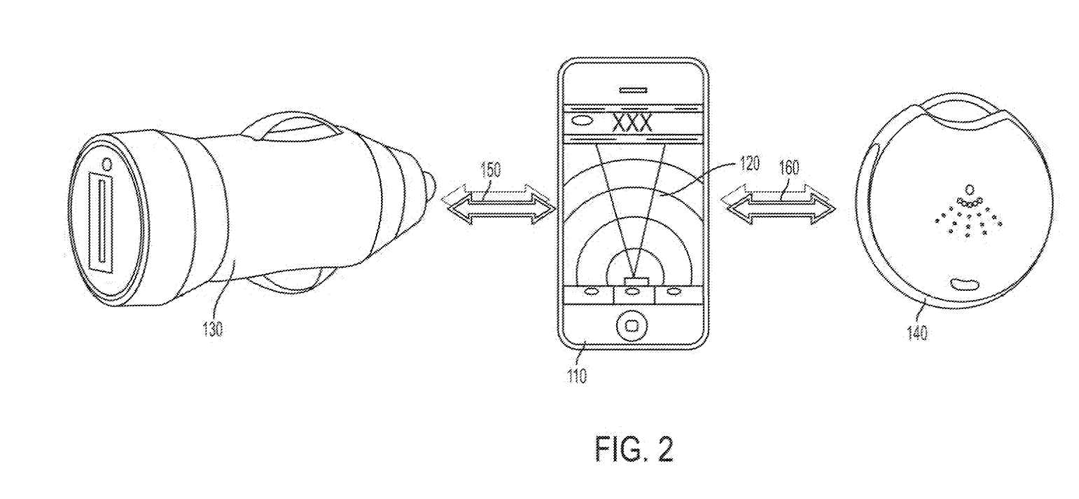

FIG. 2 shows a perspective view of an exemplary embodiment of the vehicle tag and object inventory system comprising a mobile communication device 110, a wireless device in the form of a vehicle tag 130, and a wireless device in the form of a tag 140. An exemplary screen shot of a vehicle tag 130 and object inventory application 121 that may be used to initiate, configure, and operate the security and information system is being shown on the mobile communication device 110. As can be seen in FIG. 2, the vehicle tag 130 and the tag 140 may communicate 150, 160 with the mobile communication device 110, and vice versa. The functionality, components, and operation of the tag 140, the vehicle tag 130, and the application 121 running on the mobile communication device 110 are described in further detail below.

### Vehicle Tag and Object Inventory Application

The system has a software component (i.e., a vehicle tag and object inventory application 121) installed on the mobile communication device 110. The application 121 is installed on the mobile communication device 110 and generates a graphical user interface that, in conjunction with the device's physical user interfaces, provides controls over the system's behavior and displays information associated with the tags 140 and vehicle tags 130. The software components include instructions that are executed by the processor 111 of the mobile communication device 110. The application 121 allows the user to interact and configure the tags 140 and vehicle tags 130 and to configure mobile communication device 110 behavior in the context of the tags 140 and vehicle tags 130. The application 121 processes data received from the vehicle tags 130 and tags 140 such as receiving voltage readings and determining the operational state of the vehicle using the voltage readings. The application 121 may also record voltage readings, received commands, time, date, and location of wireless devices 130, 140, locations corresponding to the various operational states of the vehicle, tag inventories corresponding to operational states. etc. The application 121 may also notify the user when a tag 140 or vehicle tag 130 is out of transmission range and communications are no longer received by the mobile communication device 110. The application 121 may provide the user with the ability to “page” a tag 140 or vehicle tag 130 by “beeping” the tag 140 or vehicle tag 130 to allow the user to find it, indicating to the user when and where the tag 140 or vehicle tag 130 was last in range, and generating a visual and/or audio alert to aid the user in locating the device (as well as functionality for ending such an alert or alarm). Finally, the application 121 may manage the pairing, connection, and disconnection between the mobile communication device 110 and the tags 140 or vehicle tags 130.

Accordingly, the application 121 serves as a COD figuration and status view tool for all authenticated and connected tags 140 and vehicle tags 130, as well as to provide notifications in response to configured tag 140 or vehicle tag 130 related events. A tag 140 or vehicle tag 130 may be added to the system via the application user interface. Once added, the user may configure the application 121 to interact with the tag 140 or vehicle tag 130 in different ways. The user may configure the application 121 to notify the user when the tag 140 or vehicle tag 130 has moved out of a preselected proximity range, a transmission range, when the tag 140 or vehicle tag 130 has come back into range, or when the tag 140 or vehicle tag 130 has moved (through the use of an accelerometer 136 on the tag 140 or vehicle tag 130), as well as when an inventory of tags does not match the inventory taken before leaving a location. Additionally, the user may remove the to 140 from the application, in which case the tag 140 may automatically return to an unpaired mode, ready to be paired again to the same, or another mobile communication device 110.

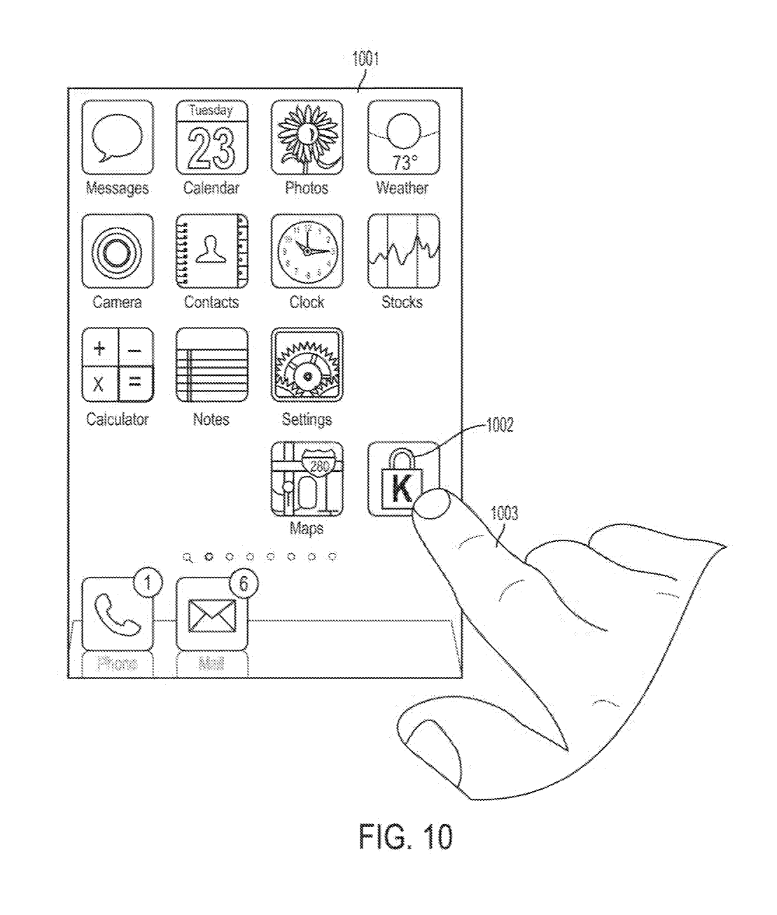

Because the application 121 is running on a mobile communication device 110 that a user may want to use for purposes other than the monitoring application, the application 121 may be configured to run in the background while the mobile communication device 110 performs other services for a user. When the application 121 is in the background, all of the proximity and alerting functions continue to work. However, instead of displaying the notifications within the application 121 using custom visual indicators, standard system notifications may be used to seamlessly notify the user without interrupting other functionality of the mobile communication device 110. Exemplary screenshots of the application are shown in FIGS. 10-12 and further description regarding the user interaction with the application is provided below,

### The Vehicle Tag

The vehicle tag 130 can be kept in a user's vehicle and may be coupled to the vehicle's electronic system such that if the vehicle is started, the vehicle tag 130 may be powered and turn on. Accordingly the vehicle tag 130 may alert the user if the user is separated from the mobile communication device 110 at the time of the vehicle being started. The functionality of the vehicle tag 130 may include many of the function of the tag 140 in that it may periodically report the signal strength readings to the mobile communication device 110. However, the vehicle tag 130 is a specialized tag that includes multiple functions that are not included in the tags 140.

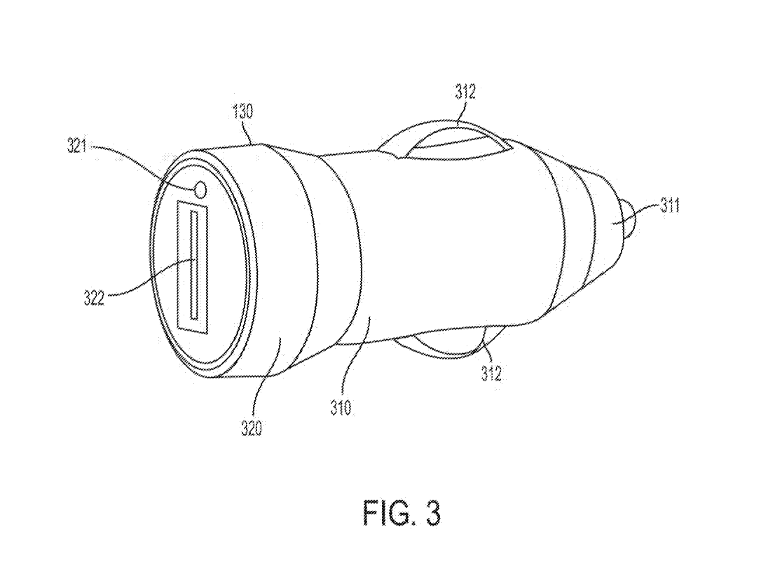

FIG. 3 shows a perspective view of an exemplary vehicle tag 130 according to an embodiment of the invention. The vehicle tag 130 may comprise a top housing 320 and a bottom housing 310, a power interface element (e.g., plug) 311 coupled to the bottom housing 310, and a USB power output element 322 and status LED indicator 321 coupled to the top housing 320. The bottom housing 310 may comprise two electrical contact members 312 that may be a portion of the power interface element 311. Additionally, some embodiments may incorporate an input button 147 (e.g., pairing button) on the top housing 320 of the vehicle tag 130 that a user may interact with.

The exemplary embodiment shown in FIG. 3 includes a wireless device (i.e., vehicle tag) 130 that may be removably and electrically coupled to a vehicle through a cigarette lighter adapter (CLA) that may typically be found in automobiles and boats. Any other configuration could also be implemented, for example, the vehicle tag 130 may be configured to removably and electrically couple to a different type of electrical system or electrical input. Additionally, the vehicle tag 130 may be configured such that it is not removable and may be electrically coupled directly to the electrical system of a vehicle or may otherwise be incorporated directly with the electrical system of the vehicle. One of ordinary skill would understand that the features and methods described herein could be incorporated using multiple different power systems, types of vehicles, and form factors of the vehicle tag 130.

The status LED indicators 321 may provide the user with information about the operational state of the vehicle, the connection and pairing status of the vehicle tag 130 with a mobile communication device 110, and the power status of the vehicle tag 130 (e.g., the vehicle tag 130 is turned on or off). Additionally, under certain user actions, the vehicle to speaker 134 may be activated to acknowledge the user action including upon activation of the pairing mode, upon successfully pairing the vehicle tag 130 to the mobile communication device 110, upon unsuccessful pairing of the vehicle tag 130, and finally, upon the vehicle tag 130 changing to a sleep mode (e.g., powering down of the transceiver 132).

The processor 131 of the vehicle tag 130 may comprise firmware or may he coupled to a computer readable medium that comprises firmware or other code that is capable of performing a method of pairing, authenticating, and communicating with a mobile communication device 110 according to embodiments of the invention described herein. Accordingly, the firmware or other software components may be capable of authenticating the vehicle tag 130 and application 121, determining, and reporting signal strength indicator (RSSI) readings, determining and reporting voltage readings, operational state readings, and movement indicators of the vehicle tag 130, and in some embodiments, configuring and performing a security service including alerting a user if the mobile communication device 110 is out of a predetermined range.

Pairing and authentication of the vehicle tag 130 and the mobile communication device 110 may include a mutual authentication sequence that ensure the vehicle tag 130 and mobile communication device 110 only communicate with vehicle tags 130 and mobile devices that are authorized to do so. The authentication procedure may include connection to a mobile communication device 310, receiving a pairing, communication from the mobile communication device 110 including an authentication code, calculating an authentication code independently of the mobile communication device 110, verifying that the authentication code received and calculated match, and if they match, entering a connected state, in which the vehicle tag 130 communicates with the mobile communication device 110.

Additionally, in some embodiments, the vehicle tag 130 may be capable of communicating with the mobile communication device 110 through a broadcast mode. In the broadcast mode, the vehicle tag 130 may not pair to any one mobile communications device and instead, the vehicle tag 130 may periodically broadcast a message, wherein the message may include all the data that it has gathered from the vehicle. This broadcast can be received by all mobile communication devices 110 that are in range and retrieve the data within the broadcast message. The mobile communication device 110 may be configured to listen for these broadcast communications at all times, periodically, or when in a broadcast mode as well. The broadcast communications can be implemented with encryption such that only mobile communication devices 110 that know the encryption key will be able to decipher and retrieve the data encapsulated in the broadcast data. Accordingly, the vehicle tag data may be protected against undesired third party devices listening in on the communications.

The connected state may indicate that the mobile communication device 110 is authenticated by the vehicle tag 130 but because the system implements mutual authentication, the mobile communication device 110 may now authenticate the tag 140 to ensure both devices are authorized to communicate. Accordingly, after authenticating the mobile communication device 110, the vehicle tag 130 may calculate a tag authentication code and send the tag authentication code to the mobile communication device 110. The application 121 on the mobile communication device 110 may then independently calculate the tag authentication code and verify the received tag authentication against its own calculation. If they match, the vehicle tag 130 may enter an authenticated state and the vehicle tag 130 and mobile communication device 110 may communicate normally. If the verification is unsuccessful at any point, the mobile communication device 110 and the vehicle tag, 130 may not be authenticated but the vehicle tag 130 may stay in the connected state and generate a new authentication value to be authenticated by the application.

### The Tag

According to some embodiments of the present invention, the wireless device may be provided in the form of a tag 140. In some embodiments of the invention, the tag 140 may be as thin and as small as possible. Small dimensions allow the tag 140 to be easily attached to an object of any size without interfering with the use of the object. Additionally, smaller tags 140 may be inconspicuous and a malicious third party may not notice the tracking and proximity device attached to the monitored object. Alternatively, a user may wish to advertise the use of the tracking device, to dissuade potential malicious third parties from trying to take the monitored object and as such, in some embodiments, the tag 140 may be provided in a larger form factor as well.

As explained previously, the capabilities explained above regarding the vehicle tag 130 (outside of the specialized measurement of characteristics unique to the vehicle to 130) may all be provided in a tag 140. As can be seen in FIG. 1, the vehicle tag 130 is in large part a tag 140 with additional power interface components and voltage measuring components to provide additional functionality. More details regarding the tag 140 functionality may be found in application Ser. No. 13/612,576, titled “Proximity Tag for Object Tracking,” filed Sep. 12, 2012, by Gutierrez et al., which is incorporated herein, in its entirety, for all purposes. The authentication, pairing, state diagrams, and communication techniques of the tag 140 are disclosed in detail in the above-referenced application.

### II. Exemplary Methods

In embodiments of the invention, the mobile communication device 110 continually sends wireless communications to a wireless device in the form of a tag 140 or vehicle tag 130 The wireless devices may take a reading of the received communications and may return a wireless communication response including: a signal strength reading to the mobile communication device 110 at regular intervals in continuous cycles or may wait for an event to occur based on the readings or for a command from the mobile communication device 110 to send a response. The messages may be encrypted and difficult to intercept or tamper with. If the vehicle tag 130 loses contact with the mobile communication device 110, the mobile communication device 110 and/or the vehicle tag 130 may alert a user through a warning condition and alarm condition.

### Wireless Device Pairing, Authentication, and Connecting

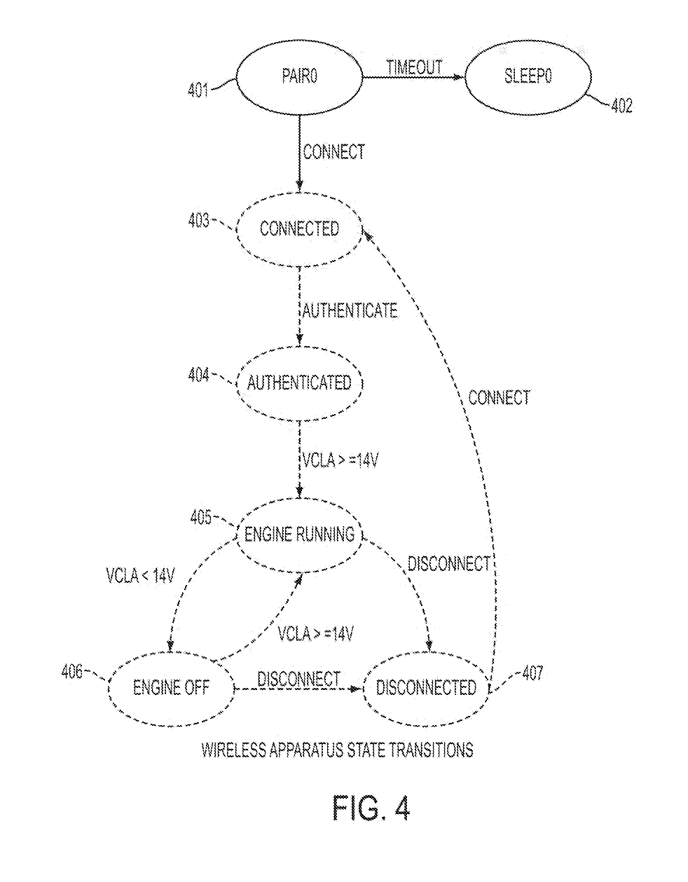

In order for the vehicle tag 130 and the mobile communication device 110 to monitor the operational state of the vehicle, determine the parking locations of the vehicle, and monitor inventories of wireless devices attached to important items, the system may be initialized through the devices being paired, connected, and mutually authenticated. FIG. 4 illustrates the different hardware states that the vehicle tag 130 may enter in relation to the mobile communication device 110 according to embodiments of the present invention. The different states relate to initial powering up of the vehicle tag 130, a first pairing to a mobile communication device 110, connecting to the mobile communication device 110, authenticating the mobile communication device 110 and being, authenticated by the mobile communication device I 0, determining an operational state of a vehicle including both engine running and engine of based on a voltage reading, disconnecting from the mobile communication device 110, and entering a sleep mode.

First, a vehicle tag 130 may be plugged into an electrical input to the electrical system of a vehicle. In some embodiments, the vehicle tag 130 may be removably coupled to the electrical system and in other embodiments, the vehicle tag 130 may be hard-wired, securable coupled, or otherwise integrated into the electrical system of the vehicle. Depending on bow the vehicle tag 130 is coupled to the electrical system of the vehicle, the vehicle tag 130 may either sleep for long periods while the vehicle is turned off (e.g., if the electrical system of the vehicle provides power even when the engine is turned off, power off if no electricity is provided from the electrical system as the wireless device may depend on the electricity provided by the vehicle in order to operate, or may time out and turn off after a specific period of time.

In a vehicle that only provides power when in an accessory mode or engine running mode, when the vehicle is powered up from an engine stopped or parked mode, the vehicle tag 130 may enter an initial Pair0 state 401. The Pair0 state 401 is entered upon the first attempt at pairing when no pairing has occurred previously and thus there is no associated mobile communication device 110. To start the vehicle tag 130 pairing to the user's mobile communication device 110, the user may launch the vehicle tag and object inventory application 121 on the mobile communication device 110 and may select add a vehicle tag. The user may then electrically couple the vehicle tag 130 to the electrical system of the vehicle.

Upon power up, the vehicle tag 130 may enter a pairing mode for a predetermined period of time 10 seconds) upon power up. In the pair state, the vehicle tag 130 may attempt to pair with a predetermined mobile communication device 110. If the vehicle tag 130 is not able to connect to the predetermined mobile communication device 110, the vehicle tag, 130 may move to a sleep0 mode 402. The sleep0 mode 402 may include a special state where the vehicle tag 130 is dormant and there is no associated mobile communication device 110. This is the default setting when the vehicle tag 130 is manufactured and delivered to a user before connecting to any mobile communication device 110. Once a pairing occurs, the vehicle tag 130 may remember the. mobile communication device 110 last paired to and try to connect to that mobile communication device 110 whenever awake. If successfully paired, the application 121 will display a message to the user that pairing was successful. If not, the application 121 may report an error to the user.

During pairing, the vehicle tag 130 may advertise its presence to any available Mobile communication devices 110 within pairing range. At this point, the user may connect the mobile communication device 110 and the tag 140 by adding the tag 140 through the application 121 running on the mobile communication device 110. A timer is started during pairing such that the vehicle tag/tag 130, 140 advertise its presence with a pairing message for only a predetermined period of time. If no mobile communication device 110 connects to the tag 140 before the timeout, the tag 140 returns to the Sleep0 state 402. The LED indictor 135 may flash a particular color (e.g., green) to remind the user that the tag 140 has started to advertise its presence to any available mobile communication devices 110 within pairing range.

During the advertising period, the vehicle tag and object inventory application 121 on the mobile communication device 110 may recognize the advertising message and may allow the user to add the tag 140 through pairing with the mobile communication device 110. Once successfully paired the status LED indicator 135 may stop flashing, may change color, or may complete any other change to indicate to the user that pairing has successfully completed. Additionally, a melody may play that informs the user of the successful pairing. Alternatively, a red flashing light, a failure melody, or any other suitable indicator may be provided to a user if the pairing is not successful.

In some embodiments, the vehicle tag 130 may communicate and pair with more than one mobile communication device 110 at any one time. In the case where more than one mobile communication device 110 is present at a given time, the vehicle tag 130 may be configured to assign a specific time period to each mobile communication device 110 on which the two devices may communicate so that the communication between the mobile communication device 110 and the vehicle tag 130 do not collide or overlap with other mobile communication devices 110 or other devices communicating with the vehicle tag 130. For example, in some embodiments, a piconet or other organized or ad hoc communication network may be established between the vehicle tag 130 and the multiple mobile communication devices 110 to ensure all of the mobile communication devices 110 receive the communication from the vehicle tag 130. A piconet may include a designated master device (in this case the vehicle tag 130) communicating with multiple slave units (the mobile communication devices 110) such that the master receives a message from each slave unit device at a designated time slot and may transmit messages to all of the slaves at the same time. Any other suitable organized or ad hoc network may be implemented by the vehicle tag 130 and mobile communication device 110.

Additionally, in some embodiments, the pairing may be accomplished through near-field communication (NFC) pairing techniques as an alternative, or in addition, to the radio frequency (RF) communications pairing technique described above. For example, mobile communication devices 110 equipped with NFC capabilities may be paired with NFC equipped vehicle tags or stickers that can be programmed to automate the pairing steps described above. When the mobile communication device 110 comes within range of the NFC equipped vehicle tag, one of the mobile communication devices 110 and vehicle tags 130 may exchange identification information to the other mobile communication device 110 and vehicle tag 130 which then pairs the mobile communication device 110 and vehicle tag 130 together. The communication scheme moving forward would work as described above in relation to multiple communication devices pairing with a single vehicle tag 130. Accordingly, the NFC tags exchange identification information and complete the pairing steps.

The NFC pairing technique may operate at a slower speed than RF communication techniques, but may consume far less power and does not require multiple messages to be sent back and forth for pairing. Additionally, although the NFC communications have a shorter range than RF communications (e.g., 20 cm), the shorter distance may reduce the likelihood of unwanted interception of identification information and pairing. Accordingly, NFC may be particularly suitable for crowded areas where correlating a signal between a receiving device and a transmitting device becomes difficult. Additionally, some embodiments may implement NFC pairing with an unpowered device by using, a passive tag with extra power being provided by the device illuminating the tag. For example, a phone 110 may be turned off and, a contactless smart credit card, a smart poster, may all still implement NFC tags which may be powered by, for example, a. vehicle tag 130.

Once paired, the vehicle tag 130 may enter a connected state 403 because a mobile communication device 110 receives the advertised pairing messages and may send a connection message to the vehicle tag 130 after being added through the application 121 by the user. If a mobile communication device 110 connects to the vehicle tag 130 while in the Pair0 401 or Disconnected 407 states, the vehicle tag 130 records the ID of the mobile communication device 110 and thereafter may connect to the mobile communication device 110 without going through a Pair0 state 401. The mobile communication device 110 has now established a connection to the vehicle tag 130; however, the mobile communication device 110 and the vehicle tag 130 are not yet mutually authenticated. At this stage, all features are disabled except for authentication. As explained above in reference to the tag 140 and vehicle tag 130 sections, the wireless device (e.g. tag 140 or vehicle tag 130) and mobile communication device 110 may now attempt to perform a mutual authentication. If the authentication process fails, it can be restarted from the beginning at any time.

The mobile communication device 110 may now attempt to authenticate the vehicle tag 130. If the vehicle tag 130 is successfully authenticated, the vehicle tag 130 may receive a message from the mobile communication device 110 and the vehicle tag 130 enters an authenticated state 404. The vehicle tag 130 and the mobile communication device 110 may now communicate and interact as designed, including providing the functionality described herein.

Once authenticated, the vehicle tag 130 may enter one of the operational states depending on the operational state of the vehicle. For example, the vehicle tag 130 may enter an engine running state 405, accessory power state (not shown), or an engine off state 406. The running state 405 may be entered if the engine of the vehicle is running and thus, using the example described above, the voltage of the vehicle's electrical system is above 14 volts (14.4 volts) due the alternator running. Accordingly, the vehicle tag 130 may enter an engine running or running state 405 when the voltage reading from the vehicle exhaust system exceeds a threshold. While in the running state 405, the vehicle tag 130 may periodically take voltage readings, determine an operational state of the vehicle, report the voltage readings and/or operational state of the vehicle to the mobile communication device 110, determine and report the signal strength readings just as with typical (non-vehicle) tags, or complete any other suitable operations. The vehicle tag 130 and the application 121 running on the mobile communication device 110 may continue to monitor the voltage readings on the input of the electrical system of the vehicle to determine whether or not the engine of the vehicle is running.

Alternatively, in some embodiments, the vehicle tag 130 may determine an intermediate voltage level for an accessory power state where the voltage reading is below 14 volts but is above 0 volts (and thus the vehicle tag 130 remains powered). Additionally, if the vehicle tag 130 determines that the voltage is either below the voltage threshold of 14 volts (in the case where there is no intermediate state) or below the accessory power state voltage threshold of 12 volts, the vehicle tag 130 may move to an engine of state 406. When the vehicle tag 130 shifts to the engine off or standby mode from the engine running state, the vehicle tag 130 may report the shift in operational state reading, and/or voltage reading shift to the mobile communication device 110. The mobile communication device 110 may then determine that the operational state of the vehicle indicates the vehicle is parked. Accordingly, a number of functions may be completed by the mobile communication device 110 as described herein including the storage of a parking location in a parking location database 127 and the storing of a tag inventory for those wireless devices that are within communication range of the mobile communication device 110.

The vehicle tag 130 may also enter a disconnected state 407 any time that the mobile communication device 110 disconnects from the vehicle tag 130. For example, the user may enter a data input into the application 121 that the vehicle tag 130 should not be monitored. When the vehicle tag 130 is in the disconnected state 407, the vehicle tag 130 may periodically attempt to connect (e.g,, automatically connect) to the mobile communication device 110. The vehicle tag 130 may enter the disconnected state 407 either from the engine turning off (and thus not powering the vehicle tag 130) or the connection to the mobile communication device 110 (i.e., tether) being broken.

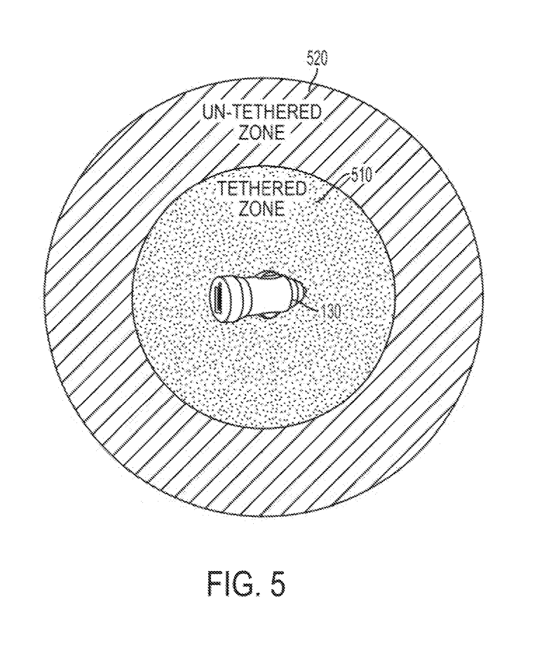

For example, a vehicle tag 130 may determine that the operational state of the vehicle is an engine running state 405 and the user may leave the vehicle and move to a distance outside of the communication range of the vehicle tag 130 or the mobile communication device 110, this distance may be considered an “un-tethered zone.” FIG. 5 shows a diagram of the different communication status zones for a vehicle tag 130, according to embodiments of the present invention. As can be seen in FIG. 5, the vehicle tag 130 may have a tethered zone 510 that is a communication range for the transceiver 132 of the vehicle tag 130. The tethered zone 510 may be customizable by the user and may have different settings such as, for example, short, medium, or long, which may correspond to the distance that the transceiver 132 of the vehicle tag 130 may send and receive messages. An mobile communication device 110 outside of the tethered zone 510 (i.e., in the un-tethered zone 520) may not communicate with the vehicle to 130.

When the tether (i.e., connection) between the mobile communication device and the vehicle tag 130 is broken (i.e., either by powering off the engine or the mobile communication device 110 walking away and exceeding the range of the tethered zone), some embodiments of the present invention may store a GPS location of the vehicle as a “last seen” location of the vehicle. This may be different than the parking location determined when the operational state of the vehicle is determined to be that the vehicle is parked. Accordingly. the presentation of the directions may change to directions to last seen location, instead of parking location. In some embodiments, the system may treat a mobile communication device 110 entering the un-tethered zone and communication being lost, the same as the operational state of the vehicle indicating that the vehicle is parked, and as such, may treat the last known GPS location of the mobile communication device 110 as the parking location.

Additionally, in embodiments of the present invention which incorporate a signal strength reading and reporting for the vehicle tag 130, the signal strength reading may inform a mobile communication device 110 that the vehicle tag 130 is being separated from the mobile communication device 110 or is nearing the un-tethered zone range where communication may be lost. As such, in some embodiments, the mobile communication device 110 may determine that the operational state of the vehicle is parked, by a signal threshold, alert threshold, parking threshold value, or any other threshold related to the signal strength has been reached. As such, the mobile communication device 110 knows that the vehicle to 130 is being separated from the mobile communication device 110 and as such it is unlikely the car is still running. Accordingly, vehicles which have irregular power systems that remain running or at a higher voltage than normal when parked, may still be accurately determined to be parked and location be saved. Additionally, a more accurate parking location may be determined and stored by the mobile communication device 110 determining that the vehicle is parked before losing connection with the vehicle tag 130.

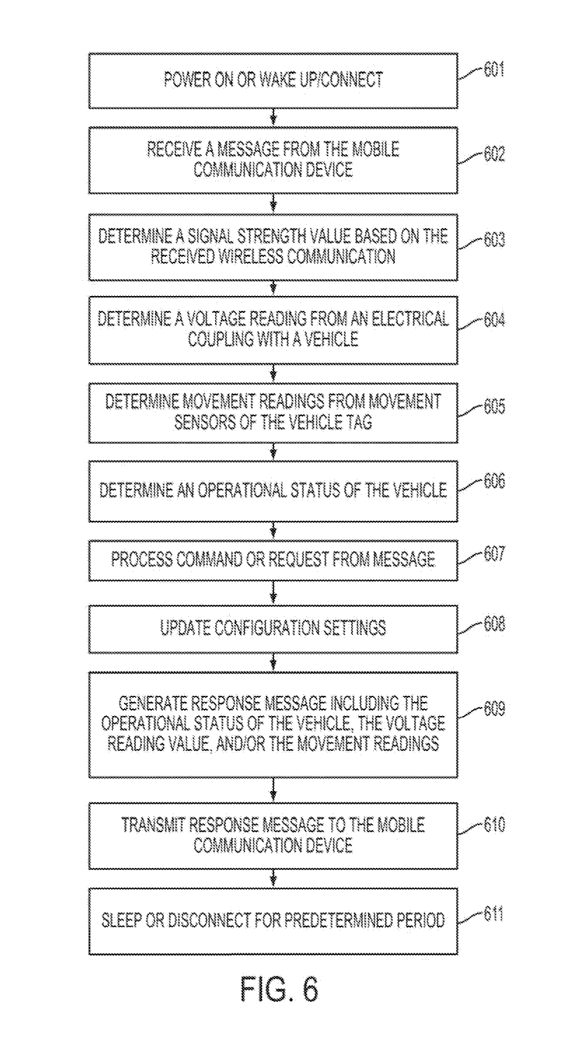

FIG. 6 shows a flowchart illustrating a method of determining and reporting an operational state of a vehicle by a vehicle tag 130, according to embodiments of the invention. The method of FIG. 6 may be performed by the vehicle tag 130 while in an authenticated state with a mobile communication device 110.

In step 601, the wireless device attached to the vehicle (vehicle tag 130) is activated from a predetermined period of inactivity, idle, or rest. The vehicle tag 130 may not disconnect from the mobile communication device 110, but may not be active other than waiting for the next reading of a wireless communication from the mobile communication device 110. The vehicle tag 130 may enter an idle or inactive state in order to conserve battery power. However, in some embodiments the vehicle tag 130 may still be able to receive communications from the mobile communication device 110 and respond to any commands received in the wireless communications.

In step 602, the vehicle tag 130 receives a wireless communication request message from the mobile communication device 110. The wireless signal request message may comprise a command or may merely include identification information so that the vehicle tag 130 may determine the signal strength of the wireless signal request message

In step 603, the vehicle tag 130 calculates a signal strength value based on the received wireless communication. The signal strength may be calculated through a received signal strength indicator (RSSI) reading and calculation, The RSSI reading may be preprocessed and inverted such that it is a positive number (i.e., −60 dB reading is delivered as 60) or the raw RSSI values may be collected. More information regarding this may be obtained from related U.S. application Ser. No. 13/612,576. titled “Proximity Tag for Object Tracking,” filed Sep. 12, 2012, by Gutierrez et al., which is incorporated herein, in its entirety, for all purposes.

In step 604, the vehicle tag 130 determines a voltage reading from an electrical coupling with the electrical system of a vehicle. The vehicle tag 130 may determine a voltage reading of a vehicle h measuring the voltage at the electrical input of the vehicle tag 130 that is electrically coupled to the input of the vehicle's electrical system. The voltage reading may include the analog to digital conversion (ADC) voltage reading from the voltage divider 139F equivalent of the voltage at the electrical input of the vehicle tag 130. The voltage reading may provide a vehicle tag 130 or a mobile communication device 110 with information regarding the operational state of a vehicle (i.e., a voltage reading may change depending on the operational state of the vehicle). Accordingly, the vehicle tag 130 may report the voltage reading to a mobile communication device 110 and the voltage reading may be used to determine an operational state of a vehicle.

In step 605, the vehicle tag 130 determines movement readings or movement characteristics from movement sensors 136 of the vehicle tag 130. The vehicle tag 130 may measure movement characteristics including acceleration, vibration, or other effects or forces on movement sensors 136 included in the vehicle tag 130. The vehicle tag 130 may report the output from the movement sensors 136 to the mobile communication device 110, and the output may be used to determine an operational state of the vehicle.

In step 606, the vehicle tag 130 determines an operational state of the vehicle. The vehicle tag 0130 may determine an operation state of the vehicle through a number of different methods. For example, the vehicle tag 130 may make a determination of the operational state of the vehicle based on a voltage, movement characteristics, or through any other suitable method disclosed herein.

For example, the vehicle tag 130 may determine the operational state of the vehicle using the voltage reading by comparing the voltage reading to a voltage threshold. A voltage threshold may include a predetermined voltage level that indicates whether a vehicle's engine is running. For example, if the voltage reading is below the voltage threshold, the operational state of the vehicle may be set to indicate the vehicle is parked or stopped. For instance, when automobile alternators are operating, the electrical system of the automobile may have an output voltage of 14.4 volts instead of the typical battery voltage of 12 volts. Accordingly, by comparing the measured voltage to a voltage threshold of 14 volts, the mobile communication device 110 or the vehicle tag 130 may be able to determine whether the automobile's engine is running (e.g., voltage reading above 14 volts) or not (e.g., voltage reading of 12 volts). Accordingly, the operational state of the automobile may be determined b the vehicle tag 130 or the mobile communication device 110 using the voltage readings. The voltage threshold may be adjustable by a user or the mobile communication device 110 depending on the type of vehicle being operated.

In some embodiments, the movement characteristics may provide additional information in order for an accurate, or independent, determination of an operational state of a vehicle. For example, when the vehicle is an automobile, the movement characteristics measured by the vehicle tag 130 including the acceleration measured by an accelerometer 136 may inform a vehicle tag 130 that the vehicle is not parked even though the engine may no longer be “running” or the voltage may be below the voltage threshold. Accordingly, if a movement sensor (e.g., accelerometer 136) in a vehicle tag 130 determines that the vehicle tag 130 is being moved, the vehicle tag 130 may include a movement indicator in the next wireless signal response sent to the mobile communication device 110.

After determining the operational state of the vehicle, the vehicle tag 130 may determine an operational state reading that may inform a mobile communication device 110 as to the current operational state of the vehicle. For example, the operational state reading may include a flag, binary digit reading, code, or any other information that may be interpreted by a mobile communication device 110 as providing the operational state of the vehicle. For instance, when a vehicle is in a running state, the operational state reading may include a single digit, “1”. Accordingly, if the vehicle is in a parked engine stopped, or engine off operational state, the operational state reading may include a “0”. Accordingly, the mobile communication device 110 may immediately understand the operational state of the vehicle and may make decisions and take actions accordingly. For example, when a mobile communication device 110 receives an operational state reading that changes to a 0 from a previous operational state reading of 1, the mobile communication device 110 immediately knows that the vehicle tag 130 is indicating that the vehicle has entered an operational state of off engine off, engine stopped, etc., and that the vehicle is parked. Accordingly, the location of the mobile communication device 110 may be stored in to parking location database 127 for fixture reference. Accordingly, the most accurate parking location may be determined because the mobile communication device 110 does not move from the vehicle before the parking location is determined.

In step 607, the vehicle tag 130 processes a command or request within the wireless signal request. For example, the wireless signal request may comprise a command to disconnect from the mobile communication device 110 and enter a disconnected state 407. Any other suitable command may be included in the wireless signal request.

In step 608, the vehicle tag 130 updates configuration settings according to information included in the wireless communication. The wireless signal request may comprise a change of configuration settings for the vehicle tag 130 based on the previously sent wireless response message sent to the mobile communication device 110, a data input by a user, or the entering of a zone tag area that automatically changes the profile settings for the mobile communication device 110. Accordingly, the mobile communication device 110 may update the configuration settings of the vehicle tag 130 at any time by sending the updates embedded within wireless signal requests.

In step 609, the vehicle tag 130 generates a response message including the operational state of the vehicle, the voltage reading value, the signal strength reading, the movement characteristics, and/or the movement indicator. The vehicle tag 130 may also include any other suitable information in the wireless response message including commands (e.g., a “find my phone” command), location information (e.g., triangulation information, longitude/latitude coordinates from a GPS component, etc.), time, date, device identification information, special requests, etc. Any suitable information may be included in the wireless signal response as one of ordinary skill in the art would recognize.

In step 610, the vehicle tag 130 transmits the response message to the mobile communication device 110 and in step 611, the vehicle tag 130 goes into an idle or inactive state for a predetermined period. The period of the idle or inactivity may be included in a configuration setting as the rate of transmissions of the voltage readings or reports for the vehicle tag 130. The vehicle tag 130 may then repeat this cycle by activating when the next cycle begins (step 601).

Additionally, in some embodiments, the vehicle tag 130 may perform steps of the described method using a broadcast mode. When operating in the broadcast mode, the vehicle tag 130 may generate and transmit a wireless communication without receiving a message from the mobile communication device 110 and may sleep until the next periodic time to transmit information. The vehicle tag 130 may then wake up, make measurements and determinations, and send another broadcast message including the information, as described above.

### Determining a Parking Location

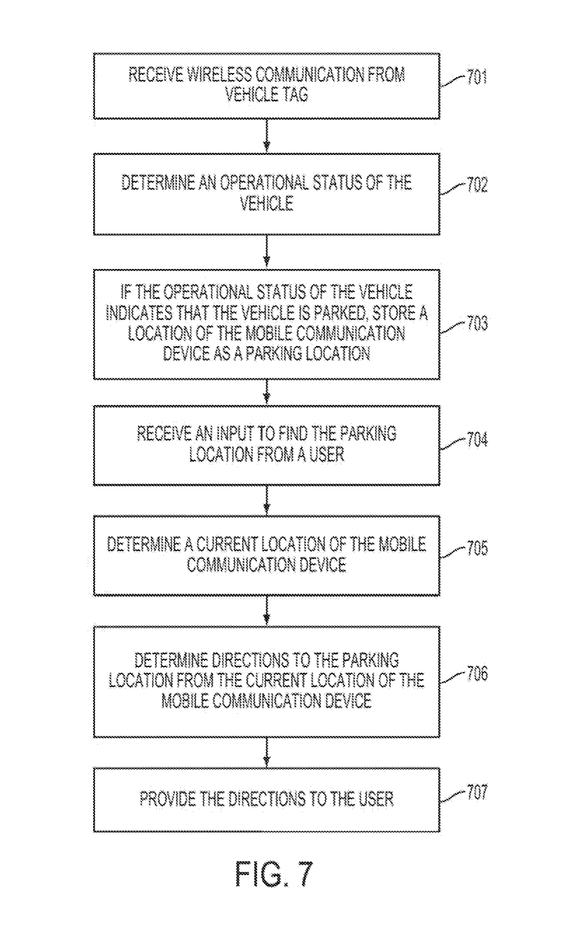

FIG. 7 shows a flowchart illustrating a method of determining a parking location performed by a mobile communication device 110, according to embodiments of the invention.

In step 701 the mobile communication device 110 receives a wireless communication from a vehicle tag 130. The wireless communication or wireless response may include any information determined by a vehicle tag 130. For example, any and/or all of the information determined above including a voltage reading, voltage threshold, movement characteristics, movement indicator, operational state reading, as well as any other information that may be determined by the vehicle tag 130 or be useful for the mobile communication device 110.

In step 702, the mobile communication device 110 determines an operational state of the vehicle. The mobile communication device 110 may determine an operational state of the vehicle through a number of different methods. For example, the mobile communication device 110 may accomplish any of the calculations or determinations explained above in reference to FIG. 6.

Accordingly, in some embodiments, the mobile communication device 110 may receive a voltage reading from the vehicle tag 130, may compare the received voltage reading to a voltage threshold, and if the voltage reading is below the voltage threshold, may determine that the vehicle has an operational state that indicates that the engine is running.

In another embodiment, the mobile communication device 110 may receive a movement indicator that the mobile communication device 110 may use to determine the operational state of the vehicle. For example, if the voltage reading indicates that the engine has turned off but the movement characteristics or movement indicator from the vehicle tag 130 shows that the vehicle is still moving, the mobile communication device 110 may not determine that the vehicle is stopped yet. Accordingly, the mobile communication device 110 may have flexibility to take a number of different characteristics or pieces of information in determining whether a vehicle is parked or running.

In yet another embodiment, the vehicle tag 130 may determine the operational state of the vehicle and may provide an operational state reading to the mobile communication device 110. In this instance, the mobile communication device 110 may merely determine the operational state corresponding to the received operational state reading and may set the operational state to indicate such a state. Accordingly, a number of different methods for determining the operational state of the vehicle may be used by the mobile communication device 110.

In step 703, the mobile communication device 110 may determine that the operational state of the vehicle indicates that the vehicle is parked and the mobile communication device 110 may store a location of the mobile communication device 110 as a parking location of the vehicle.

In step 704, the mobile communication device 110 may receive a user input to find and provide directions to the parking location of the vehicle. The user input may include a voice command, physical input on the mobile communication device 110, electronic communication from another device, or any other suitable method.

In step 705, the mobile communication device 110 may determine a current location of the mobile communication device 110. For example, the mobile communication device 110 may determine the location using position components 119B (e.g., GPS positioning information) of the mobile communication device 110, may request a position from another device (e.g., a server computer, a fob, or a tag), or may use any other suitable method.

In step 706, the mobile communication device HO may determine directions to the parking location from the current location of the mobile communication device 110. Once the mobile communication device 310 has determined the mobile communication device's current location and the vehicle's parking location, the mobile communication device 110 may determine directions for returning to the vehicle's parking location from the current location through any suitable method. For example, the mobile communication device 110 may investigate routing programming stored on the mobile communication device 110 or may request directions from a server computer connected through a communication network (e.g., wireless communications, data network, etc).

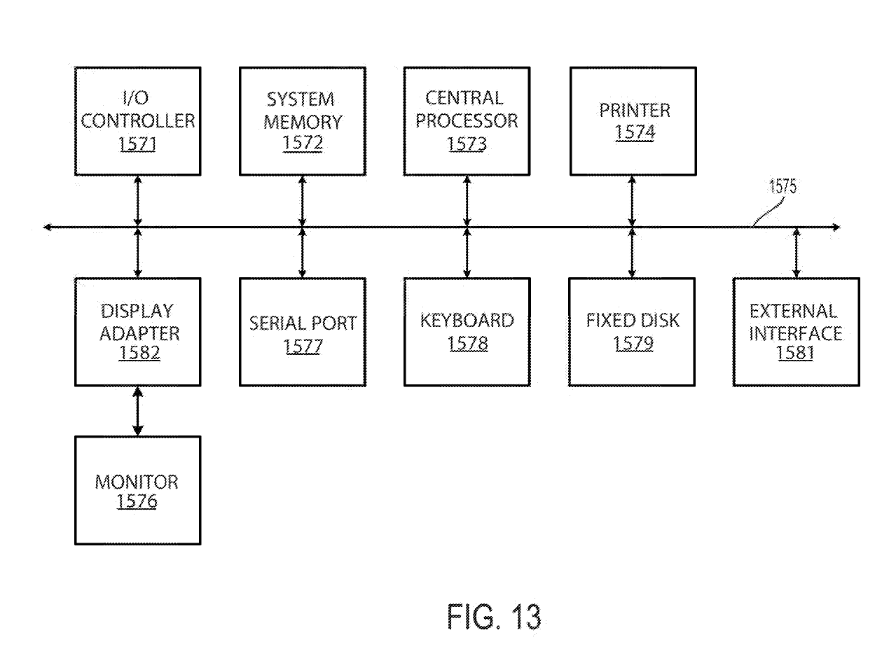

In step 707, the mobile communication device 110 provides the directions to the user. The directions may be provided through any suitable method. For example, a map may be displayed on a screen or display of the mobile communication device 110 that shows the location of the user and the parking location of the vehicle. An exemplary screenshot showing a map display is provided in FIG. 13. The map may provide directions to the user and may provide multiple routes that a user may take with estimated times for traveling through those routes. However, the directions may be provided through any other suitable medium. For example, the mobile communication device 110 may use a speaker to direct the user by sound, may send a message to another device of the consumer's that may provide the directions, may provide text directions, or any other suitable method of providing directions to a user.

### Tag Inventory Monitoring

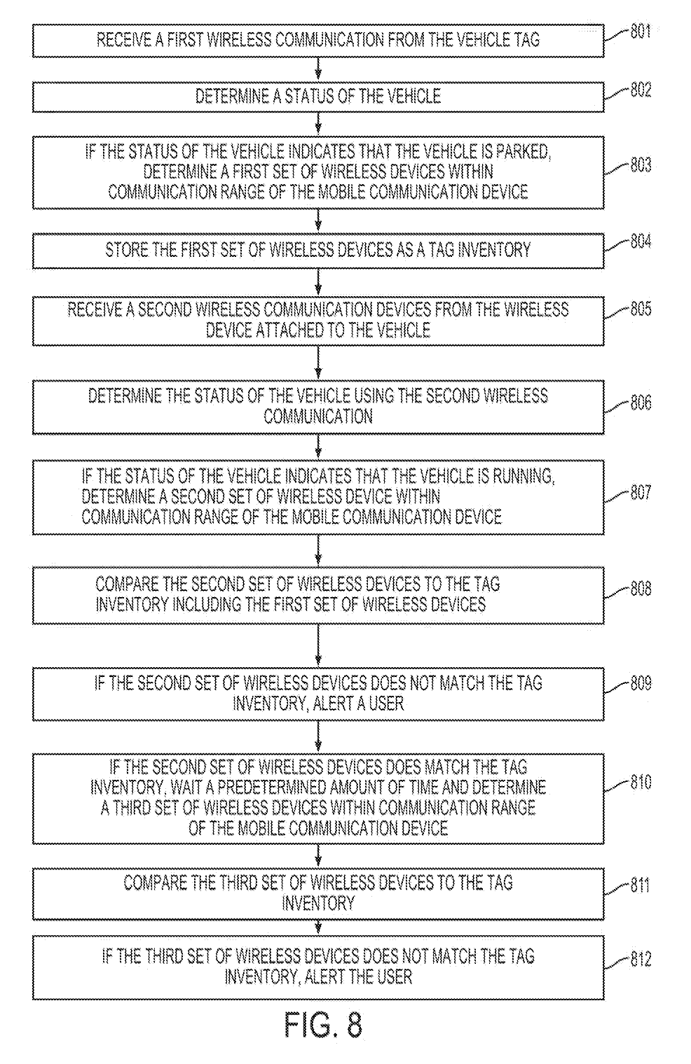

FIG. 8 shows a flowchart illustrating a method of tag inventory monitoring by a mobile communication device 110, according to embodiments of the invention. In some embodiments, the mobile communication device 110 may monitor the presence of wireless devices (e.g., tags 140) that are attached to objects of interest to a user based on the operational state of a vehicle. For example, embodiments of the present invention determine and store an inventory of wireless devices that are within communication range of the mobile communication device 110 when a vehicle is parked (i.e., generate a tag inventory). The wireless devices may be attached to objects of interest (e.g., tools, equipment, valuable items, etc.) and as such, the system may provide an inventory of these important objects, articles, or other items that a user is interested in monitoring. Additionally, embodiments may further generate another wireless device inventory (tag inventory) when the vehicle is determined to be running again, and may alert a user if any tags (and corresponding articles of interest that were in the original inventory are not present once the vehicle is running again.

In step 801, the mobile communication device 110 receives a first wireless communication from a vehicle tag 130.

In step 802, the mobile communication device 110 determines an operational state of the vehicle. The mobile communication device 110 may determine the operational state through any suitable method as described herein and through the same methods as explained in reference to FIG. 7 above.

In step 803, if the operational state of the vehicle indicates that the vehicle is parked, the mobile communication device 110 determines a first set of wireless devices (i.e., a first list of objects that are attached to tags 140) within communication range of the mobile communication device 110. The mobile communication device 110 may determine the first set of wireless devices within communication range by “pinging” or sending a wireless request to the wireless devices the mobile communication device 110 is paired or connected with. The wireless devices may receive the wireless request and may send a wireless response including any information that informs the mobile communication device 110 of the identity of the wireless device. Accordingly, the mobile communication device 110 may understand that the wireless device is present and within communication range of the mobile communication device 110. In some embodiments, the RSSI reading or other signal strength reading may be used in determining whether a plurality of wireless devices are within communication range as disclosed in related U.S. application Ser. No. 13/612,576, titled “Proximity Tag for Object Tracking,” filed Sep. 12, 2012, by Gutierrez et al., which is incorporated herein, in its entirety, for all purposes.

In step 804, the mobile communication device 110 stores the first set of wireless devices within communication range as a tag inventory. The tag inventory may be stored in a tag inventory database 128 or other memory on the mobile communication device 110 to ensure the information is available for future comparison. Any suitable information about the wireless devices may be stored. For example, a serial number, identification number, tag name, or any other information may be stored about the wireless devices that respond to the wireless request. Any information provided in the wireless response or any data stored in the mobile communication device 110 associated with an identified wireless device may be stored in relation to the tag inventory.

In step 805, the mobile communication device 110 receives a second wireless communication from the vehicle tag 130. Typically, the second wireless communication occurs after the vehicle has changed operational states from a first operational state to a second operational state (i.e., from parked or engine of to moving or engine on). Accordingly, the vehicle tag 130 may communicate the changed operational state to the mobile communication device 110.

In step 806, the mobile communication device 110 determines the operational state of the vehicle using the second wireless communication. The mobile communication device 110 may determine the operational state of the vehicle using the same method or a different method than used in determining the operational state after the first wireless communication.

In step 807, if the operational state of the vehicle indicates that the vehicle is running, the mobile communication device 110 determines a second set of wireless devices (i.e., a second list of objects) within communication range of the mobile communication device 110. The second set of wireless devices may be stored in the tag inventory database 128 or may be cached in a temporary memory.

In step 808, the mobile communication device 110 compares the second set of wireless devices to the tag inventory including the first set of wireless devices. The second set of wireless devices may be compared to the first set of wireless devices to ensure that all of the wireless devices that were present when the vehicle was parked are present when the vehicle is leaving. Accordingly, if any wireless devices are missing, the user may be alerted.

In step 809, if the second set of wireless devices does not match the tag inventory, the mobile communication device 110 may alert a user. The alert may include information about which item is missing, the last monitored location of the item, and any other information relevant to the user. Accordingly, the user may be notified or alerted before leaving the proximity of the location and may be able to avoid losing an object or having to backtrack all the locations the user visited in a day to determine where he/she left his/her important object.

In step 810, if the second set of wireless devices does match the tag inventory, the mobile communication device 110 waits a predetermined amount of time and determines a third set of wireless devices within communication range of the mobile communication device 110. There may be times when a wireless device is close enough to the vehicle that the wireless device is within communication range with the mobile communication device 110 but the wireless device may not be present within the vehicle. Accordingly, it may be beneficial to wait a predetermined period of time that is short enough that the user has not traveled too far in the vehicle, but also is not too short that the vehicle has not left yet, to determine if any tags that were within communication range when the vehicle was parked, are still within communication range after leaving. Accordingly, the process may be repeated after a predetermined period of time.

In step 811, the mobile communication device 110 compares the third set of wireless devices to the tag inventory. The comparison may be against the originally stored tag inventory or the second tag inventory,

In step 812, if the third set of wireless devices does not match the tag inventory, the mobile communication device 110 alerts the user.

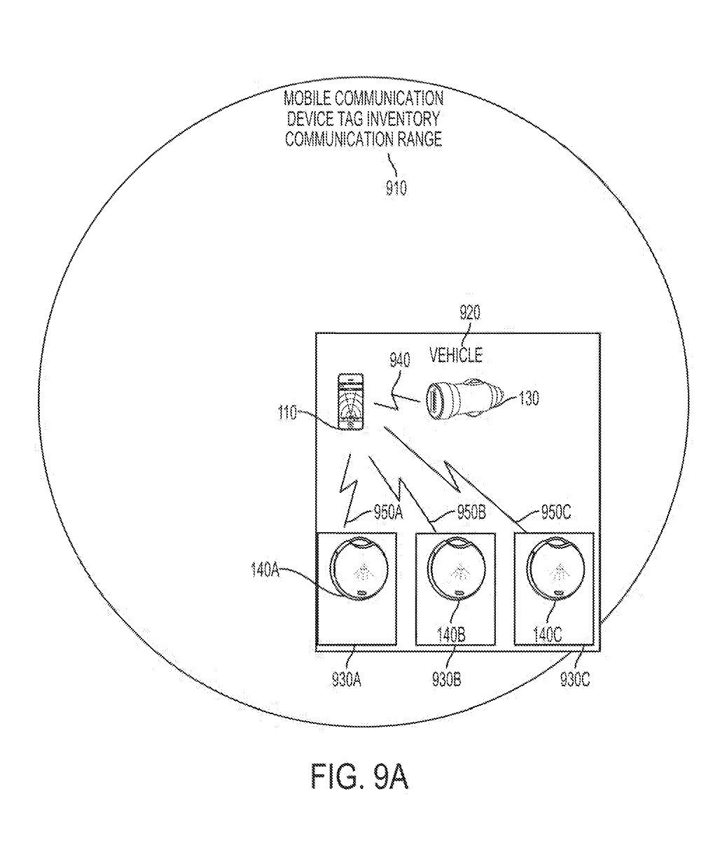

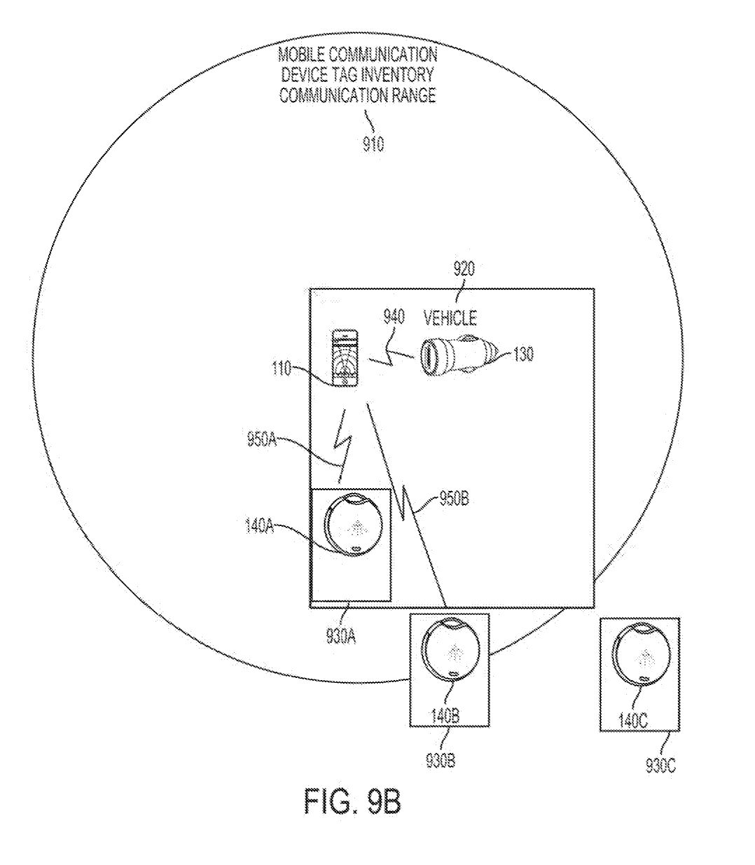

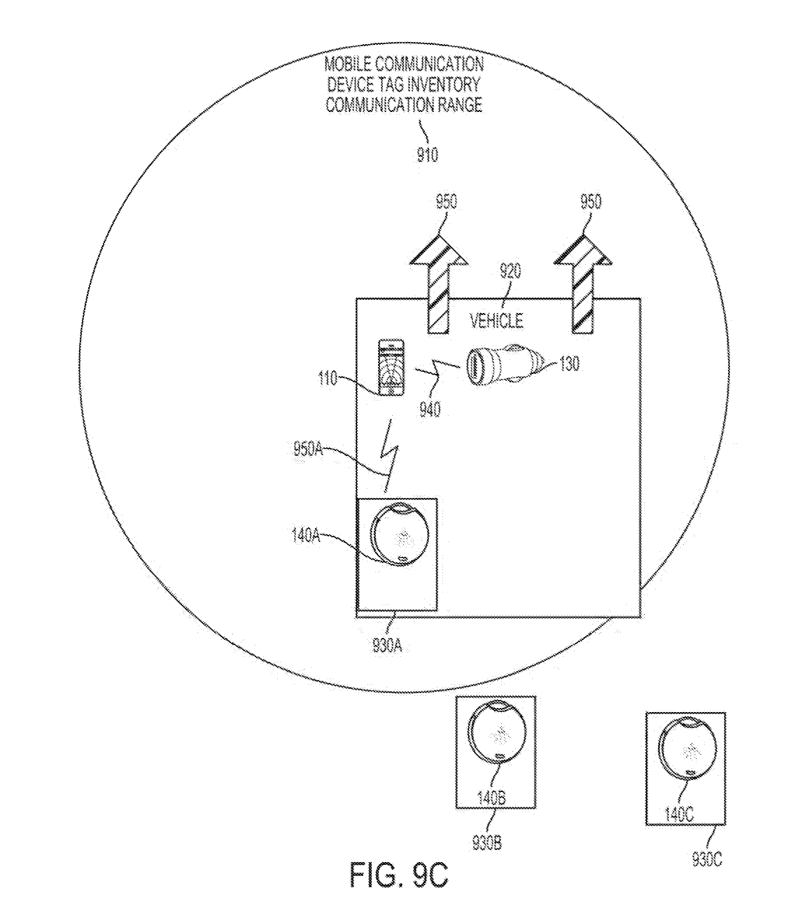

For example, FIGS. 9A-9C show an exemplary situation where a wireless device attached to a vehicle 920 may communicate via a wireless communication 940 with a mobile communication device 110. The mobile communication device 110 may take an inventory of a plurality of wireless devices 140A-140C that is attached to a plurality of objects of interest 930A-930C. In FIG. 9A, a vehicle is parked at a worksite and a plurality of wireless devices 140A-140C is attached to a plurality of articles of interest (e.g., tools) 930A-930C that are located within the vehicle 920. If the engine of the vehicle 920 just stopped, the vehicle tag 130 may determine a voltage reading that is below the voltage threshold and may report the change in the operational state of the vehicle 920 to the mobile communication device 110 in a wireless communication 940, as described previously. Accordingly, the mobile communication device 110 may determine that the operational state of the vehicle 920 has changed and may determine a first set of wireless devices within communication range 910 of the mobile communication device 110 (i.e., a first tag inventory). The user may exit the vehicle 920 and begin working with the various tools or other items of interest (e.g., sales merchandise, equipment, etc.) at the location. Accordingly, the articles of interest 930A-930C may be removed from the vehicle 920.

FIG. 9B shows the vehicle 920 at a later time when the user has returned to the vehicle 920 and started the engine. Accordingly, the vehicle tag 130 may determine that the operational state of the vehicle 920 has changed from a parked or stopped position to a running position. Accordingly, the vehicle tag 130 may send a wireless communication 940 to the mobile communication device 110 informing the mobile communication device 110 of the operational state update. Accordingly, the mobile communication device 110 may determine, a second set of wireless devices within communication range of the mobile communication device 110 (i.e., a second tag inventory). However, not all of the wireless devices 140A-140C are within the vehicle 920. As shown in FIG. 9B, a first wireless device 140A is in the vehicle 920, a second wireless device 140B is not within the vehicle 920 but is within communication range 910 of the mobile communication device 110, and a third wireless device 140C is outside of communication range 910 of the mobile communication device 110. Accordingly, the second tag inventory may not match the first tag inventory because the third wireless device 140C may not communicate with the mobile communication device 110. Accordingly an alert may be sent informing the user that the third wireless device 140C is not present. However, the alert may not inform the user that the second wireless device 1408 is missing. Accordingly, the user may check for the third wireless device 140C but may not see or know that the second wireless device 140B is not within the vehicle 920.

FIG. 9C shows the vehicle 920 after a predetermined period of time has elapsed and the user has started moving in the direction of arrows 950 and away from the original parking location. In some embodiments of the present invention, the mobile communication device 110 may wait a predetermined amount of time and may determine a third set of wireless devices (i.e., third tag inventory) within communication range 910 of the mobile communication device 110. Accordingly, the mobile communication device 110 may move far enough away to ensure that any devices that were not within the vehicle 920 and are no longer within the communication range 910 of the mobile communication device 110. As shown by FIG. 9C, once the vehicle 920 moves away from the original parking location, the second wireless device 140B and the third wireless device 140C are outside the communication range 910 of the mobile communication device 110. Accordingly, the third tag inventory may not match the first tag inventory or the second tag inventory, and the user may be alerted to the missing second wireless device 140B.

Alternatively, in sonic embodiments, the mobile communication device 110 may trigger a third wireless device inventory based on movement distance instead of time. For example, the mobile communication device 110 may determine a movement distance of the mobile communication device 110 since the operational state of the vehicle indicated that the vehicle is running, and if the movement distance is larger than a movement distance threshold, determine a third set of wireless devices within radio communication range 910 of the mobile communication device 110.

### Exemplary Screenshots of Embodiments of the Application

As described previously, in some embodiments of the invention, the system may have a software component (i.e., application 121) installed on to mobile communication device 110. The user interface of the vehicle tag and object inventory application 121 provides control over the system's behaviors and allows a user to customize the system to maximize its effectiveness. For instance, the distance from the mobile communication device 110 that the mobile communication device 110 may communicate with a wireless device and the system's responses to alarm conditions may be defined and configured by the user using the application 121 running on the mobile communication device 110. Accordingly, the application 121 may synchronize the mobile communication device 110 and the wireless device 130, 140, receive a data input from a user (i.e., a user input), and update the wireless device 130, 140 with information corresponding to the data input. The data input may correspond to configuration settings for the wireless device 130, 140. The application 121 may update the configuration settings and then include the configuration settings in the next wireless signal request sent to the wireless device.

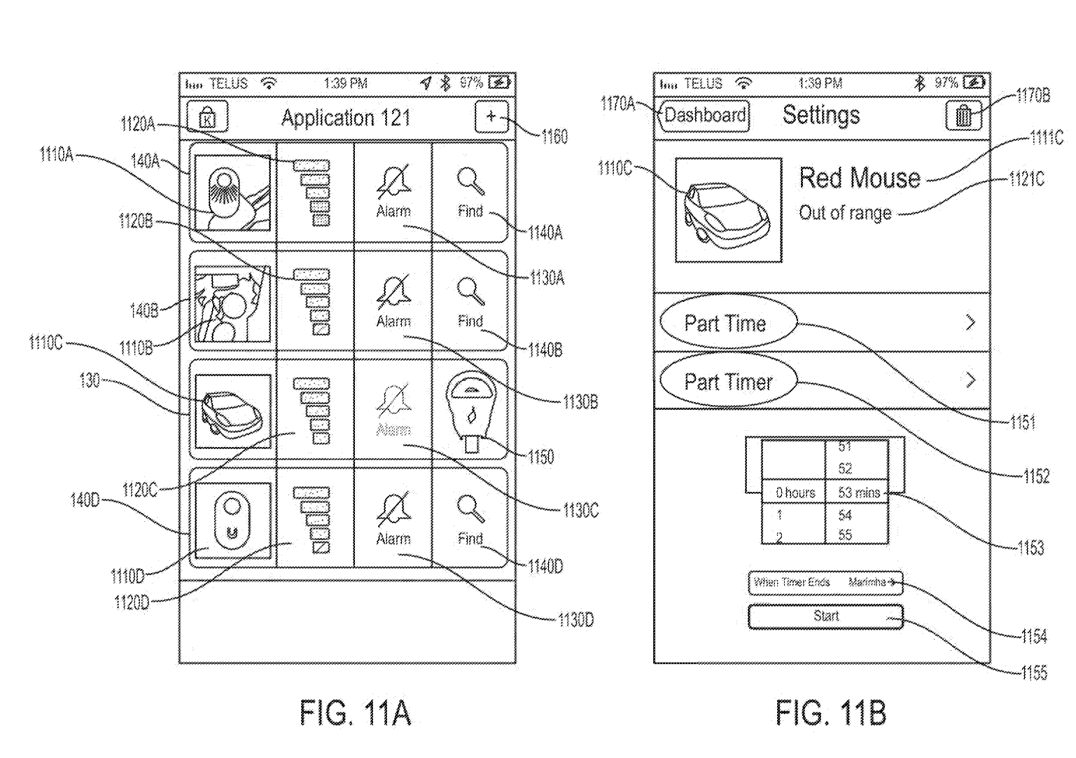

FIGS. 10-12 show exemplary screenshots of an exemplary application 121 for the mobile communication device 110 shown in FIG. 2. FIG. 10 shows an exemplary screenshot of the display 1001 of the mobile communication device 110 after the application 121 has been downloaded and shows a user 1003 launching the application 121 by tapping on the application icon 1002. FIG. 11A shows an exemplary home screen of the vehicle tag 130 and object inventory application 121 showing the different tags 140A-140C being tracked (e.g., the first set or the second set of wireless devices or objects) as well as the vehicle tag 130, an indication 1120A-1120D of the proximity of the tag 130, 140A-C to the mobile communication device 110, a visual icon 1110A-1110D for easy identification, an alarm status (mute, disabled, or active) 1130A-1130D, “find my tag” functionality 1140A-1140D, and a vehicle tag specific functionality 1150. FIG. 11A shows an exemplary embodiment of the application 121 where the main screen may be implemented as a number of rows for each previously registered tag 140A-140C and vehicle tag 130. Each row includes a visual identifier 1110A-1110D and proximity indication 1120A-1120D to quickly and easily inform the user of the proximity status of the registered tags 130, 140A-140C. Additionally, the proximity indicator 1120A-1120D may have different colors to indicate a power status for the tag 130, 140A-140C. For example, if the power status is in a low state, the proximity indicator 1120A-1120D could be red while if the power status is full, the proximity indicator could be green, blue, or some other color. Additionally, other information could be provided through the color of the proximity indicator 1120A-1120D. For example, if the tag 140A-140C is moving further from the mobile communication device 110, the proximity indicator 1120A-1120D may be a red color to indicate that the danger level is increasing, while the color could change to blue if the tag 140A-140D is approaching the mobile communication device 110. Any other suitable information may be displayed through color as well. Additionally, or alternatively, the proximity indicator 1120A-1120D may illuminate more or less bars as the tag 140A-140C moves away from the mobile communication device 110. Additionally, the proximity indicator could be inverted such that the indicator displays the signal strength of the received wireless devices 130, 40A-140C, such that the larger the proximity indicator 1120A-1120D, the closer the tag may be to the mobile communication device 110.

The home screen (as shown in FIG. 11A) allows the user to determine more information about each tag 130, 140A-140C as well as configure each tag 130, 140A-140C individually. From the home screen, the user may additionally be able to re-organize and/or remove tags 130, 140A-140C. Furthermore, if the user taps on a row, the application 121 enters a details screen associated with the selected tag 130, 140A-140C where configuration settings may be set and further details provided about the tag 130, 140A-140C (as shown in FIG. 11B). Additionally, in some embodiments, the user may be able to select a “find” button 1140A-1140D from the home screen that initiates the “find my tag” functionality. Additionally, the home screen allows the user to configure settings for the parking functionality by touching the parking button 1150 or may add a tag by hitting the add tag button 1160.

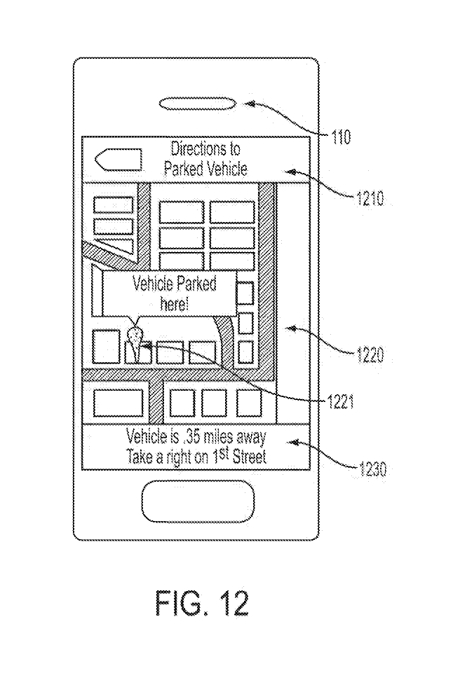

FIG. 11B illustrates an exemplary details display of a vehicle tag 130. The title page may provide a visual identifier 1110C and a name 1111C for the vehicle tag 130 (e.g., the name 111C of the tag is “Red Mouse” and the visual identifier 1110C is a picture of a red automobile). The details display may further comprise a park time function 1151 that displays the time that the vehicle was parked as well as a park timer 1152 that may be set by a user to count down a parking permit time or otherwise inform the user when a particular period of time has expired since the timer was started (e.g., the vehicle was parked). The park timer 1152 may be set by the user using a timing input 1153, may set an alarm 1154, and may be started with an input button 1155. The vehicle tag 130 may also be unpaired, disconnected, or otherwise deleted from the mobile communication device 110 through the delete button 1170B, A back button 1170A may return the user to the main page shown in FIG. 11A. A directions input button (not shown) may also be displayed in the details page of the vehicle tag 130. The directions input button may provide a user with directions to the latest parking location of the vehicle. An exemplary embodiment of the directions functionality is shown in FIG. 12.

FIG. 12 shows an exemplary screenshot of the application 121 showing the parking location directions functionality 1210. The parking location directions functionality 1210 may show directions to the stored parking location of the vehicle that was stored during the method described above with respect to FIG 7. The application 121 shows the user a map 1220 where the parking location was stored. The map 1220 may be displayed and centered on the parking location (e.g., last stored location of the parking location). A visual indicator 1221 (e.g., a pin or other icon) may be displayed on the map 1220, pin-pointing the captured coordinates and a transparent circle may be displayed around the pin to indicate the level of accuracy of the reading. A caption may be displayed above the pin. The main text may display a human readable name of the location of the tag. Alternatively or additionally, the latitude/longitude information may be shown. Furthermore, below the map is a caption 1230 indicating the distance from the current position to the last seen position. The caption 1230 may additionally or alternatively display directions for returning the user to the stored parking location from the current location of the mobile communication device 110.

### III. Technical Advantages

Embodiments of the present invention provide a number of technical advantages. The vehicle tag and object inventory system provides a simple, efficient, interactive, customizable, and effective solution to monitoring the location of a vehicle and ensuring that a user has possession of their important objects before leaving a location. The system allows a consumer to rest assured that their monitored objects are with them before they leave a location and that the user may be alerted if their objects of interest are not in their vehicle before they leave.

Additionally, embodiments of the present invention determine an operational state of a vehicle using voltage readings, movement characteristics, and/or other operational characteristics. As such, the system is more accurate at determining the operational state of a vehicle and may ensure that the vehicle is actually parked before storing a parking location, determining a tag inventory, or completing any other tasks related to the behavior of the vehicle. Accordingly, instead of relying strictly on the radio communication link between the mobile communication device 110 and the vehicle tag 130 to determine a parking location, present embodiments may allow for a stronger radio frequency communications link to be implemented leading to fewer false positives, more flexibility in placement of the two devices within the vehicle, as well as more accurate determination of a vehicle's operational state.

Additionally, because the parking location is stored at the time the automobile is parked and does not rely on a loss of communication between the mobile communication device 110 and a vehicle to 130, a more accurate location may be determined for the parking location. It may be possible in some systems to move a far distance away from a vehicle before a radio communication link is broken and if the system relied on disconnection of a radio link in order to determine a parking location, a stored parking location may be far away from the actual parking location. In unfamiliar locations this distance may be confusing and may not allow a user to find their vehicle.

Embodiments of the present invention are portable and customizable. For example, embodiments of the present invention are directed around a removable and electrically coupled vehicle tag 130. Accordingly, the vehicle tag may be used in any number of different vehicles with any number of different electrical systems, operating voltages, voltage thresholds, etc., and may be customized for each vehicle through multiple different profiles and settings configured on the vehicle tag 130 through the mobile communication device 110.

Additionally, the vehicle tag 130 may connect to multiple different mobile communication devices 110 at either the same time or at different times. Accordingly, the vehicle tag 130 may allow multiple mobile communication devices 110 to take the inventor of multiple different wireless devices depending on the paired wireless devices for each mobile communication device 110. This avoids a single vehicle being responsible for customizing all of the wireless devices for each person that may use the vehicle. For example, a single automobile may be used by multiple contractors. Each contractor may have their own tools with their own set of tags attached thereto. Embodiments of the present system allow each contractor's mobile communication device 110 to manage the tag inventory and management of tags attached to items of interest. Accordingly, the automobile system does not have to manage multiple profiles, may not provide false alarms regarding tags that are not present due to the tags being with a different contractor, and each tag inventory may be tailored to the particular contractor that owns or operates the particular mobile communication device 110. Accordingly, the system is easier to customize for a user, requires less management during operation, and is more accurate for each user or operator of the vehicle.

Additionally, embodiments of the present invention automatically save and store the parking location of a vehicle for later retrieval by a user. As such, the system does not require a user to remember to save the parking location, interact with the system in any way or choose any settings or otherwise be involved in the savings process. Accordingly, embodiments provide an easy and simple solution for remembering and receiving directions to a vehicle's parking location.

In another embodiment of the present invention, the vehicle tag 130 may communicate with one or more mobile communication devices 110 using a “broadcast mode.” Using the broadcast mode, the vehicle tag 130 may communicate with multiple devices simultaneously without the need to manage connections to each device. As such, the broadcast system may be a simpler and easier management design while providing the advantages described above.

FIG. 13 shows a block diagram of subsystems that may be present in computer apparatuses that are used in the system shown in FIG. 1. The various participants and elements in the previously described figures may operate using one or more computer apparatuses to facilitate the functions described herein. Any of the elements in the figures may use any suitable number of subsystems to facilitate the functions described herein. Examples of such subsystems or components are shown in FIG. 13. The subsystems shown in FIG. 13 are interconnected via a system bus 1575. Additional subsystems such as a printer 1574, keyboard 1578, fixed disk 1579 (or other memory comprising computer readable media), monitor 1576, which is coupled to display adapter 1582, and others are shown. Peripherals and input/output (I/O) devices, which couple to 110 controller 1571, can be connected to the computer system by any number of means known in the art, such as serial port 1577. For example, serial port 1577 or external interface 1581 can be used to connect the computer apparatus to a wide area network such as the Internet, a mouse input device, or a scanner. The interconnection via system bus allows the central processor 1573 to communicate with each subsystem and to control the execution of instructions from system memory 1582 or the fixed disk 1579, as well as the exchange of information between subsystems. The system memory 1582 and/or the fixed disk 1579 may embody a computer readable medium.

It should be understood that the present disclosure as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

Thus, the invention provides, among other things, an object tracking system for monitoring wireless devices based on an operational state of a vehicle. Various features and advantages of the invention are set forth in the following claims.

1. An object tracking system comprising:
a wireless device coupled to a vehicle, the wireless device including
a first antenna,
a first transceiver electrically coupled to the first antenna, and
a sensor coupled to the first transceiver and configured to monitor a parameter of the vehicle, the parameter related to an operational state of the vehicle; and
a mobile communication device including
a second antenna,
a second transceiver electrically coupled to the second antenna to communicate with the wireless device, and
a processor coupled to the second transceiver, the processor operable to
generate a first list of objects that are located within a communication range of the second transceiver when the vehicle is in a first operational state,
generate a second list of objects that are located within the communication range of the second transceiver when the vehicle is in a second operational state, and
compare the second list of objects to the first list of objects.

2. The object tracking system of claim 1, wherein the first operational state indicates that an engine of the vehicle is off, and the second operational state indicates that the engine of the vehicle is on.

3. The object tracking system of claim 2, wherein the sensor includes a voltage sensor configured to electrically couple to an electrical system of the vehicle, and wherein the voltage sensor monitors a voltage reading of the electrical system of the vehicle.

4. The object tracking system of claim 1, wherein the first operational state indicates that the vehicle is parked, and the second operational state indicates that the vehicle is moving.

5. The object tracking system of claim 4, wherein the sensor includes a motion sensor configured to detect movement of the vehicle.

6. The object tracking system of claim 1, wherein the wireless device includes a second processor coupled to the first transceiver and the sensor, wherein the second processor is operable to
determine the operational state of the vehicle based on the parameter of the vehicle, and
send a wireless communication that includes the operational state of the vehicle to the mobile communication device.

7. The object tracking system of claim 6, wherein the sensor includes a voltage sensor configured to electrically couple to an electrical system of the vehicle, wherein the voltage sensor outputs a voltage reading of the electrical system of the vehicle, and wherein the second processor is operable to compare the voltage reading to a voltage threshold.

8. The object tracking system of claim 7, wherein the second processor is operable to
determine that the vehicle is in the first operational state when the voltage reading is below the voltage threshold, and
determine that the vehicle is in the second operational state when the voltage reading is equal to or above the voltage threshold.

9. The object tracking system of claim 6, wherein the sensor includes a motion sensor configured to detect movement of the vehicle, and wherein the second processor is operable to
determine that the vehicle is in the first operational state when the motion sensor does not detect movement of the vehicle, and
determine that the vehicle is in the second operational state when the motion sensor detects movement of the vehicle.

10. The object tracking system of claim 1, wherein the first transceiver is operable to send a wireless communication to the mobile communication device that includes the parameter of the vehicle, and wherein the processor is operable to determine the operational state of the vehicle based on the parameter of the vehicle.

11. The object tracking system of claim 10, wherein the sensor includes a voltage sensor configured to electrically couple to an electrical system of the vehicle, wherein the voltage sensor outputs a voltage reading of the electrical system of the vehicle, and wherein the processor is operable to compare the voltage reading to a voltage threshold.

12. The object tracking system of claim 11, wherein the voltage threshold is adjustable by a user.

13. The object tracking system of claim 11, wherein the processor is operable to
determine that the vehicle is in the first operational state when the voltage reading is below the voltage threshold, and
determine that the vehicle is in the second operational state when the voltage reading is equal to or exceeds the voltage threshold.

14. The object tracking system of claim 10, wherein the sensor includes a motion sensor configured to detect movement of the vehicle, and wherein the processor is operable to
determine that the vehicle is in the first operational state when the motion sensor does not detect movement of the vehicle, and
determine that the vehicle is in the second operational state when the motion sensor detects movement of the vehicle.

15. The object tracking system of claim 1, wherein the processor is operable to generate an alert if the second list of objects is different than the first list of objects.

16. The object tracking system of claim 1, wherein the processor is operable to
wait a predetermined period of time,
generate a third list of objects that are located within the communication range of the second transceiver when the predetermined period of time ends, and
compare the third list of objects to one of the first list of objects and the second list of objects.

17. The object tracking system of claim 1, wherein the processor is operable to
determine a movement distance while the vehicle is in the second operational state,
compare the movement distance to a movement distance threshold,
generate a third list of objects that are within the communication range of the second transceiver when the movement distance is equal to or above the movement distance threshold, and
compare the third list of object to one of the first list of objects and the second list of objects.

18. The object tracking system of claim 1, wherein the mobile communication device includes a display, and wherein the display displays at least one of the first list of objects and the second list of wireless device.

19. The object tracking system of claim 1, wherein the processor is operable to
store a location of the vehicle when the vehicle is in the first operational state, and
generate directions to the stored location of the vehicle upon receiving a user input.

20. The object tracking system of claim 19, wherein the mobile communication device displays at least one of the stored location of the vehicle and the directions to the stored location of the vehicle.

21-47. (canceled)
